(19) United States
(12) Patent Application Publication
(10) Pub. No.: US 2024/0241223 A1
(43) Pub. Date: Jul. 18, 2024

(54) IMPROVEMENTS IN AND RELATING TO MEASUREMENT APPARATUSES

(71) Applicant: CAMBRIDGE ENTERPRISE LIMITED, Cambridge (GB)

(72) Inventor: Phillip STANLEY-MARBELL, Cambridge Cambridgeshire (GB)

(73) Assignee: CAMBRIDGE ENTERPRISE LIMITED, Cambridge (GB)

(21) Appl. No.: 18/562,409

(22) PCT Filed: May 27, 2022
(86) PCT No.: PCT/EP2022/064490

§ 371 Date: Nov. 20, 2023

(30) Foreign Application Priority Data
May 27, 2021 (GB) 2107609.6

(51) Int. Cl. G01S 7/48; G01S 17/89

(52) U.S. Cl. CPC G01S 7/4808; G01S 17/89

(57) ABSTRACT

A computer-implemented method for sampling data from a measurement device for representing uncertainty in measurements made by the measurement device, the method comprising: obtaining a data set comprising time-sequential data elements generated by the measurement device; and: (a) calculating a statistic of a sub-set of data elements consecutive within the data set; (b) comparing the value of the statistic to a reference value; and, (c) if the value of the statistic differs from the reference value by less than a threshold amount, then: modifying the sub-set by appending to the sub-set at least one additional data element which is subsequent to the sub-set; and, repeating steps (a) to (c) for the modified sub-set of data elements; (d) if the value of the statistic differs from the reference value by more than said threshold amount, then: outputting the sub-set collectively as a sample set of data elements generated by the measurement device for representing uncertainty in measurements made by the measurement device; repeating steps (a) to (d) in respect of a subsequent sub-set of data elements consecutive within the data set.

This application claims priority from GB2107609.6 filed 27 May 2021, the contents and elements of which are herein incorporated by reference for all purposes.

### FIELD OF THE INVENTION

The present invention relates to determining measurement uncertainty in measurement devices (e.g. sensors) and particularly, although not exclusively, to the processing of data sets of measurements from measurement devices for this purpose.

### BACKGROUND

Measurement apparatuses (e.g. sensors) pervade almost all aspects of modern life. From the monitoring of the operation of vehicles (e.g. engines and performance), to manufacturing apparatus and operations, power distribution networks, traffic control and telecommunications networks. The technical data produced by this monitoring is essential to helping manage these complex machines, structures and arrangements in a way that allows better efficiency and safety. The emergence of ‘Big Data’ analytics has grown hand-in-hand with the exponential growth in this technical data.

However, the ability to benefit from the analysis of such technical data sets is predicated on the accuracy and reliability of the data itself. If the data being analysed is of poor quality, then so too are the decisions that are made based on the results of that analysis. To quote and old adage: ‘Garbage in; Garbage out’.

In all measurement apparatuses, no matter how sophisticated, the ‘measurement’ will never be identical to the ‘measurand’. Following standard terminology from metrology, the true value of the input signal being measured by a measurement apparatus is known as the ‘measurand’. Similarly, the estimate of the measurand obtained as the result of a measurement process, by a measurement apparatus, is known as the ‘measurement’.

This difference, between the value of the ‘measurand’ and the value of the ‘measurement’, is either due to disturbances in the measurement instrument/sensor (e.g., circuit noise such as Johnson-Nyquist noise, or random telegraph noise, or transducer drift) or it is due to properties of the environment in which the measurement or sensing occurs (e.g. in LIDAR, so-called ‘multipath’ leading to anomalous readings). All transducers within sensors are susceptible to sensor drift over time. Sensor drift is a gradual degradation of the sensor and other components that can make readings offset from the original calibrated state. FIG. 4 schematically illustrates an example of sensor drift, which can become significant over varying time-scales (hours/days/weeks/years) depending on the nature of the transducer.

The noise in the measurement instrument/sensor and the errors in measurements due to the environment or other non-instrument factors, can collectively be referred to as ‘measurement uncertainty’.

Knowledge of measurement uncertainty associated with a technical data set permits the user to be informed about the uncertainty, and therefore the reliability, of the results of the analysis and decisions done on the basis of that data. Ignorance of this measurement uncertainty may lead to poor decisions. This can be safety critical and is of paramount importance when the decision in question is being made by a machine (e.g. driverless car, an automated aircraft piloting system, an automated traffic light system etc.) unable to make acceptable risk-assessment judgements.

The present invention has been devised in light of the above considerations.

### SUMMARY OF THE INVENTION

Measurement uncertainty might arise in time-varying measurements even in the presence of a fixed measurand (so-called ‘aleatoric’ uncertainty). The invention provides a method for quantifying aleatoric uncertainty by obtaining sets of repeated measurements when the measurand is believed to be unchanging. When the measurand changes over time, and/or when the measurement transducer within the sensor is subject to drift, simply taking an arbitrary sample of measurements at arbitrary time points will likely not result in a distribution of measurements that is representative of measurement uncertainty (aleatoric uncertainty). The invention provides a method and apparatus for estimating the probability distribution of measurements by measurement devices when the measurand changes over time.

At its most general, the invention continuously adapts a size of a set of samples used to quantify uncertainty in a signal, by obtaining the set of samples from within a time interval when the measurand is substantially unchanging. The sample set may then be used to define a probability distribution for the measurand, which represents the measurement uncertainty and permits statistical quantification of that measurement uncertainty. A consequence is that the rate at which the estimating of the probability distribution is performed (which represents measurement uncertainty and allows one to quantify the uncertainty) is continuously adapted to meet this condition.

The insight behind the invention is that it is possible to quantify the uncertainty in the measurements of a time-varying signal, by demarcating intervals of time during which the short-term characteristics (such as the variance, third moment or skewness, the fourth moment or kurtosis, or higher-order moments of their probability distribution) of a set of recent measurements, substantially do change, but where a substantial change does occur as between successive such intervals of time. The rate at which samples may be obtained from the measurand is preferably higher (e.g. much higher) than the Nyquist frequency of the measurand. This allows the sample set of data to better quantify the aleatoric uncertainty of the measurand. Put in other words, to populate the sample set of data, it is preferable to sample the measurand at a sampling rate that is sufficiently higher than any systematic rate of change of the measurement (e.g. due to sensor drift etc.) or of the measurand (e.g. a true change in the measurand) such that variation in the data within the data set is substantially not caused by (or is negligibly influenced by) the these systematic changes.

In determining where (i.e. ‘when’) to demarcate the points in time when the short-term characteristics change, thereby demarcating the bounds of the time intervals for data sampling, the invention may temporarily store (e.g. in a buffer memory) a sub-set of data samples starting with a sample corresponding to a start time of the demarcated interval of time and ending with a sample corresponding to a provisional end time of the demarcated interval of time. Extra, subsequent data samples may be added to the sub-set to increase its size, thereby to increase the provisional end time of the demarcated interval of time defined by the sub-set. The effect is to move forward in time the demarcation end point of the time-window of samples defined by the sub-set. The invention may include calculating a suitable statistic (e.g. a moment of the distribution) of the sub-set of data upon each addition of an extra data sample and starting a new sub-set of data points if the calculated statistic satisfies a pre-set criteria indicating that the short-term characteristics (such as the variance, third moment or skewness, the fourth moment or kurtosis, or higher-order moments of their probability distribution) of the sub-set of data samples (i.e. the measurements) has substantially changed.

In a first aspect, the invention may provide a computer-implemented method for sampling data from a measurement device for representing uncertainty in measurements made by the measurement device, the method comprising:
obtaining a data set comprising time-sequential data elements generated by the measurement device; and:
   (a) calculating a statistic of a sub-set of data elements consecutive within the data set;
   (b) comparing the value of the statistic to a reference value; and,
   (c) if the value of the statistic differs from the reference value by less than a threshold amount, then: modifying the sub-set by appending to the sub-set at least one additional data element which is subsequent to the sub-set; and, repeating steps (a) to (c) for the modified sub-set of data elements;
   (d) if the value of the statistic differs from the reference value by more than said threshold amount, then: outputting the sub-set collectively as a sample set of data elements generated by the measurement device for representing uncertainty in measurements made by the measurement device;
      repeating steps (a) to (d) in respect of a subsequent sub-set of data elements consecutive within the data set.

The method may include the step of calculating a representation of the distribution of the sample set of data elements generated by this sampling data from a measurement device, to represent said uncertainty in measurements made by the measurement device. The distribution is most preferably a probability distribution. The invention may thereby provide a method (and apparatus, see below) for estimating the probability distribution of measurements by measurement devices based on a small set of samples taken from a measurand believed to follow that probability distribution. Such distributions are valuable for systems that must quantify and compute using information on the uncertainty of measurements, whether those measurements are physical measurements such as from sensors or measurements of quantum information represented in qubits. The invention enables estimating the uncertainty of a measurement of e.g., a time-varying measurand from a single measurement rather than the traditional approach to characterizing uncertainty by statistical analysis of a large number of measurements. Because the invention enables the estimation of measurement uncertainty using a much smaller number of measurements, the invention provides a significant improvement in efficiency of the measurement process.

In this way, the invention adaptively determines the times when sample sets are generated, and how many samples are contained in those sample sets. For example, sample sets may be smaller in size but more frequent in the rate at which they are generated (i.e. more generated per unit of time) when the measurand is changing significantly. Alternatively, sample sets may be larger in size but less frequent the rate at which they are generated (i.e. fewer generated per unit of time) when the measurand is not changing significantly. Put in other words, the invention allows a way of adaptively changing the time-resolution of the sampling of the measurand for generating sample sets for use in representing the measurement uncertainty of the measurement device. The invention adaptively changes the number of samples in sample sets when the measurand is changing significantly and thereby also permits a more accurate depiction of the time-varying measurand in the sequence of measurements. As a result, the invention may continuously adapt a size of a set of samples used to quantify uncertainty in a signal, by obtaining the set of samples from within a time interval when the measurand is substantially unchanging (of course, the measurements taken from the measurand may change due to uncertainty). The resulting sample set may subsequently be used to define a probability distribution for the measurand. This probability distribution may more accurately represent the uncertainty in measurements taken from the measurand. It allows more accurate statistical quantification of that measurement uncertainty. The step of calculating a representation of the distribution of the sample set of data elements generated in this way, may therefore provide a more accurate representation of measurement uncertainty for the measurand.

The comparison may comprise calculating the difference (e.g. absolute difference) between the statistic and the reference value. The reference value may be calculated based on (e.g. to be equal to) the value of the statistic in respect of a previous (e.g. immediately sequentially previous) sample set of data elements. Alternatively, the reference value may be calculated based on (e.g. to be equal to) the value of the statistic calculated at step (a) in respect of the initial sub-set of data elements. In this latter case, the initial comparison step (b) will necessarily produce a difference of zero (0), but after completing the first instance of step (c), in which a new data item is added to the data set, the subsequent instance of step (a), in respect of that modified sub-set, will typically produce a non-zero difference value.

For example, because the statistic of a sub-set of data may typically change as new samples are added to it, a calculated statistic (e.g. a moment) may well not be monotonic. This can be addressed by requiring a minimum number of samples in a sub-set or data elements upon initialisation of the sub-set, and using the value of their statistic as the reference value. Additional samples may then be added to the initialised sub-set, to generate the modified sub-sets, until the criterion on comparison of the contemporaneous value of the statistic of the (modified) sub-set to the reference value is met. Accordingly, the method may include constraining the size of the sub-set such that it is not less than a pre-set minimum number of data elements. Alternatively, the reference value may be the value of the statistic associated with a previous sample set of data elements, such as the sample set generated at step (d) immediately prior to generating a new sub-set of samples when repeating steps (a) to (d) in respect of a subsequent sub-set of data elements consecutive within the data set.

The method may include constraining the size of the sub-set modified at step (c) such that it is not greater than a pre-set maximum number of data elements. This means that if a newly-added data item in a sub-set of data items, when modifying the sub-set at step (c), is significantly different to the existing data samples in the sub-set, then this may signify the onset of a significant change in the measurand which is more likely to be detected as a change in the value of the statistic calculated in respect of the modified sub-set if the size of the modified sub-set is not too large. In other words, by appropriately setting the pre-set maximum number of data elements, the user is able to suitably ‘tune’ the sensitivity of the invention in detecting significant changes in the measurand. Desirably, in the method, if the value of the statistic differs from the reference value by less than a threshold amount, and the size of the sub-set is greater than the pre-set maximum number of data elements, then the method preferably includes:
outputting the sub-set collectively as a sample set of data elements generated by the measurement device for representing uncertainty in measurements made by the measurement device;
repeating steps (a) to (d) in respect of a subsequent sub-set of consecutive data elements within the data set.

Accordingly, if the measurand remains substantially unchanging over a longer time period, the method provides a way of avoiding an undesirable fall in the sensitivity of the invention in detecting significant changes in the measurand.

The modifying of the sub-set may comprise appending to the sub-set an additional data element which is immediately subsequent to the data element corresponding to the terminal data element of the sub-set. This appending may comprise increasing the number of data elements in the sub-set so that it includes all of the data elements of the sub-set immediately prior to appending the additional data element. Alternatively, appending may comprise maintaining the number of data elements in the sub-set so that it includes all-but-one of the data elements of the sub-set immediately prior to appending the additional data element. The excluded data element may be the temporally ‘first’ data element of the sub-set. In this way, the size of the sub-set may be kept constant during the modifying of the sub-set by removing the ‘earliest’ (temporally speaking) data element to make room for the ‘latest’ (i.e. the appended) data element. The effect is that the time points demarcating the beginning and end of the sub-set, in time, move forward in time in unison in the manner of a ‘sliding window’.

Step (d) may comprise removing from the sub-set a data element most recently appended thereto and outputting the result collectively as the sample set, and repeating steps (a) to (d) in respect of a subsequent sub-set of consecutive data elements within the data set including the data element so removed. In this way, the output sample set contains data elements which are more accurately representative of the measurand and the measurement uncertainty of the measurement device. In other words, noting that the data element most recently appended to the data set in these circumstances, is the data element that conveying a significant change in the measurand, the output sample set excluding that data element better represents the measurements made while the measurand was substantially unchanging.

The statistic calculated in step (a) may comprise a statistical moment or a function of the statistical moments of the distribution of said data elements. Examples include: the first moment (mean), the second moment (variance), third moment (skewness), the fourth moment (kurtosis), or a higher-order moment of the distribution. The reference value to which a said statistic of the modified sub-set is compared may be determined according to the value of a said statistic in respect of the sub-set prior to said modification thereof.

The outputting the sub-set may comprise one or more of: storing the sample set in a memory; storing the statistic in a memory; transmitting a signal comprising the sample set; transmitting a signal comprising the statistic. For example, the sample set may be stored in a local memory or in a remote memory of a local or remote computer system, or memory unit. The transmission of the signal may be a wireless or optical transmission, or may be an electronic transmission via a data transmission line, circuit or apparatus, to a local or remote receiver. The method may comprise using a local processor and a local memory for performing the steps (a) to (d). The method may comprise using a local transmitter for transmitting the output sample sets of data elements to a remote receiver. This enables the local or remote monitoring and/or accumulation of the output sample sets of data elements generated by the method for representing uncertainty in its measurements.

In another aspect, the invention may provide a method for representing uncertainty in measurements made by a measurement device comprising the steps of obtaining a sample set of data elements generated by a measurement device according to the first aspect described above, and calculating a representation of the distribution of the sample set of data elements to represent said uncertainty.

In a second aspect, the invention may provide an apparatus for sampling data from a measurement device for representing uncertainty in measurements made by the measurement device, the apparatus comprising:
a memory unit configured for storing an obtained data set comprising time-sequential data elements generated by the measurement device; and:
a processor configured to implement the following steps:
   (a) calculate a statistic of a sub-set of data elements consecutive within the data set;
   (b) compare the value of the statistic to a reference value; and,
   (c) if the value of the statistic differs from the reference value by less than a threshold amount, then: modify the sub-set by appending to the sub-set at least one additional data element which is subsequent to the sub-set; and, repeat steps (a) to (c) for the modified sub-set of data elements;
   (d) if the value of the statistic differs from the reference value by more than said threshold amount, then: output the sub-set collectively as a sample set of data elements generated by the measurement device for representing uncertainty in measurements made by the measurement device;
   repeat steps (a) to (d) in respect of a subsequent sub-set of data elements consecutive within the data set.

The invention in its second aspect, desirably implements the method of the invention in its first aspect described above. The processor may be configured to calculate a representation of the distribution of the sample set of data elements generated by this sampling of data from a measurement device, to represent said uncertainty in measurements made by the measurement device. The distribution is most preferably a probability distribution.

The processor may be configured to modify the sub-set by appending to the sub-set an additional data element which is immediately subsequent to the data element corresponding to the terminal data element of the sub-set.

The processor may be configured, at step (d), to remove from the sub-set a data element most recently appended thereto and to output the result collectively as the sample set, and preferably to repeat steps (a) to (d) in respect of a subsequent sub-set of consecutive data elements within the data set including the data element so removed.

The processor may be configured to constrain the size of the sub-set such that it is not less than a pre-set minimum number of data elements.

The processor may be configured to constrain the size of the sub-set modified at step (c) such that it is not greater than a pre-set maximum number of data elements.

The processor may be configured such that if the value of the statistic differs from the reference value by less than a threshold amount, and the size of the sub-set is greater than the pre-set maximum number of data elements, then to:
output the sub-set collectively as a sample set of data elements generated by the measurement device for representing uncertainty in measurements made by the measurement device;
repeat steps (a) to (d) in respect of a subsequent sub-set of consecutive data elements within the data set.

The apparatus may be configured such that the statistic calculated in step (a) comprises a statistical moment or a function of the statistical moments of the distribution of said data elements.

The apparatus may be configured such that the reference value to which a said statistic of the modified sub-set is compared is determined according to the value of a said statistic in respect of the sub-set prior to said modification thereof. As an example, this the reference value used on the (N+1)^{th} sub-set is e.g. chosen to be simply e.g. the mean (“statistic”) of the elements within the N^{th} sub-set. So, the reference value used on the (N+1)^{th} sub-set may be determined according to a statistic derived from, or calculated from, the N^{th} sub-set. This may be done, for example, by simply directly using the mean of the previous set. However, the invention is not limited to using the mean.

The apparatus may be configured to calculate a representation of the distribution of the sample set of data elements therewith to represent uncertainty in the measurements made by the measurement device.

The apparatus may be configured for communication with an external memory and said outputting of the sub-set may comprise one or more of: storing the sample set in the external memory; storing the statistic in the external memory.

The apparatus may further comprise a signal transmitter, wherein the outputting the sub-set may comprise one or more of: transmitting a signal comprising the sample set; transmitting a signal comprising a representation of the distribution of the sample set of data elements.

In another aspect, the invention may provide a measurement apparatus comprising an apparatus described above configured for generating the sample set of data elements, and comprising the measurement device (e.g. a sensor unit(s)), wherein the processor is configured to calculate a representation of the distribution of the sample set of data elements to represent said uncertainty.

In yet another aspect, the invention may provide a computer programmed with a computer program which, when executed on the computer, implements the method described above in the first aspect of the invention. In a further aspect, the invention may provide a computer program product comprising a computer program which, when executed on a computer, implements the method described above in the first aspect of the invention.

Measurement uncertainty might arise in measurements even in the presence of a fixed measurand (so-called ‘aleatoric’ uncertainty). In all measurement apparatuses and sensors, no matter how sophisticated, the measurement will never be identical to the measurand.

The invention provides a method and apparatus for estimating the probability distribution of measurements by measurement devices based on a small set of samples taken from a measurand believed to follow that probability distribution. Such distributions are valuable for systems that must quantify and compute using information on the uncertainty of measurements, whether those measurements are physical measurements such as from sensors or measurements of quantum information represented in qubits. When the target probability distribution is a physical measurand, the invention enables estimating the uncertainty of a measurement of e.g. a time-varying measurand from a single measurement rather than the traditional approach to characterizing aleatoric uncertainty by statistical analysis of a large number of measurements. Because the invention enables the estimation of measurement uncertainty using a much smaller number of measurements, the invention provides a significant improvement in efficiency of the measurement process.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In another aspect, or in combination with any aspect disclosed herein, the invention may provide an apparatus and method for the application of the Bayes-Laplace Rule, also known simply as ‘Bayes Rule’, combined with a model(s) for measurand Priors based on real-time estimation of Likelihood probabilities using statistics computation. The invention may include continuously updating a mapping (e.g. a table) to represent a joint distribution ƒ_{x,Θ}(x,θ) relating measurand (θ) and measurement (x) for a sensor(s). The invention may provide a mechanism for providing (e.g. by a user or an autonomous part of a system) a description of plausible values of the measurand (θ) in the form of a Prior distribution for the measurand (θ). The invention may compute a probability (ƒ_{Θ}(θ|x)) that a given measurement value (x) made by a measuring apparatus is equal to the true value of the measurand (θ) being measured.

In a third aspect, the invention may provide a computer-implemented method for providing a probability (ƒ_{Θ}(θ|x)) that a given measurement value(s) (x) made by a measurement apparatus is the result of a given value of the measurand (θ) being measured, the method comprising:
providing a plurality of measurement values (x);
mapping (ƒ_{x,Θ}(x,θ)) the plurality of measurement values (x) to a corresponding plurality of measurand values (θ);
generating a Prior distribution (ƒ_{Θ}(θ)) for the measurand (θ) based on the mapping (ƒ_{x,Θ}(x,θ)) of measurement values (x) to measurand values (θ);
providing Likelihood function (ƒₓ(x|θ)) defining a likelihood for the measurement values (x) associated with a given measurand (θ);
calculating a Posterior function (ƒ_{Θ}(θ|x)) for the measurement using the Prior distribution and the Likelihood function according to a Bayes-Laplace rule;
outputting the value of the Posterior function as a probability that a measurement value(s) (x) made by the measurement apparatus is the result of a given value of the measurand (θ) measured thereby.

In this way, the invention provides an aggregation of a plurality of measurements from a measurement apparatus (e.g. sensor(s)) to construct a Prior distribution for the measurand. Rather than representing the joint distribution between two measurements, however, the mapping (ƒ_{x,Θ}(x,θ)) of the measurement and measurand values represents the joint distribution between the true value of the measurand and the potentially noisy measurement.

Here, a reference to the Bayes-Laplace rule, may be considered to include a reference to what is also known known as Bayes Rule or Bayes Theorem. According to the Bayes-Laplace rule, as applied to a sequence of independent and identically distributed observations (Eⱼ), it can be shown that:

$$P ( {C}_{i} \vert {E}_{j} ) = \frac{P ( {E}_{j} \vert {C}_{i} ) \times P ( {C}_{i} )}{{\sum }_{i} P ( {E}_{j} \vert {C}_{i} ) \times P ( {C}_{i} )}$$

Here, Eⱼ is a the observed/measured “effect” conditional on the “cause” Cᵢ, i.e. the measurand. The quantity P(Cᵢ|Eⱼ) is the probability of the cause Cᵢ conditional on the effect Eⱼ. The quantity P(Eⱼ|Cᵢ) is the probability of the effect Eⱼ conditional on the cause Cᵢ. The quantity P(Cᵢ) is the probability of the cause Cᵢ. This rule allows one to calculate the probability that the measured effect was the result of a specified cause (i.e. measurand).

The Posterior function may include a multiple product of the Prior distribution for a given measurand value and the respective Likelihood functions corresponding to each respective one of a plurality of the measurement values and the given measurand value. The Posterior function may include a sum, over all measurand values, of the separate products of the Prior distribution for a measurand value and the Likelihood function respect of that measurand value and all of the plurality of measurement values. The Posterior function may be calculated as the multiple product divided by the sum.

The calculating of a Posterior function (ƒ_{Θ}(θ|x)) for the measurement may comprise calculating the following Posterior function:

$${f}_{Θ} ( θ \vert x ) = \frac{{\prod }_{\{ {x}_{1} , {x}_{2} , … , {x}_{N} \}} {f}_{X} ( x \vert θ ) {f}_{Θ} ( θ )}{{\sum }_{θ ∈ 𝒟 ( Θ )} {f}_{X} ( x \vert θ ) {f}_{Θ} ( θ )}$$

Here, the set D(0) is the set of all possible measurand values (θ) of the random variable Θ, where Θ is the random denoting the measurand. In this way, the denominator of the above expression acts as a normalisation constant in which the summation integrates over the marginal ƒₓ(X|θ)ƒ_{Θ}(θ) with respect to all the measurand values (θ). The Posterior function may be calculated in respect of a single measurement value (x), in which case the quantity (X) in the Posterior function ƒ_{Θ}(θ|X) is simply a single scalar value (i.e. ƒ_{Θ}(θ|X)=ƒ_{Θ}(θ|x); N=1). Alternatively, the Posterior function may be calculated in respect of a plurality of measurement values (x₁, x₂, . . . , x_{N}), in which case the quantity (X) in the Posterior function ƒ_{Θ}(θ|X) is a vector of N separate measurement values, (xᵢ), each of which is itself one separate scalar measurement value (i.e. the vector of N measurements: X=(x₁, x₂, . . . , x_{N})T). Here, a vector notation is used in which:

$$\begin{matrix}{f}_{Θ} ( θ \vert X ) = {f}_{Θ} ( θ \vert {x}_{1} , {x}_{2} , … , {x}_{N} ) \\ {f}_{X} ( X \vert θ ) = {f}_{X} ( {x}_{1} , {x}_{2} , … , {x}_{N} \vert θ )\end{matrix}$$

The step of mapping (ƒ_{x,Θ}(x,θ)) the plurality of measurement values (x) to a corresponding plurality of measurand values (θ), may comprise any one of several optional mapping techniques, discussed below.

A mapping technique may comprise providing a mapping table (e.g. a lookup table LUT) comprising the plurality of tabulated measurement values (\hat{x}) obtained from a reference measurement apparatus or a plurality of reference measurement apparatuses, and comprising a corresponding plurality of measurand values (θ) in which each table entry for a given tabulated measurement value (or range of values) corresponds to one unique tabulated entry for a measurand value (or range of values). Alternatively, more preferably, the mapping technique may comprise providing a mapping table (e.g. a lookup table LUT) comprising the plurality of tabulated measurement value sub-ranges, or ‘bins’, (\hat{x}) extending over a range of all of the measurements obtained from a reference measurement apparatus and comprising a corresponding plurality of measurand value sub-ranges, or ‘bins’, (θ) in which each table entry for a given tabulated measurement value bin corresponds to one unique tabulated entry for a measurand value bin. This range of all of the measurements obtained from a reference measurement apparatus may be divided into successive measurement sub-ranges, or ‘bins’, preferably of equal size, in ascending order of measurement value. This may be considered as defining the ordinate axis of a frequency histogram for measurement values by the reference measurement apparatus (or probability distribution when individual frequency values per bin are divided/normalised by the total number of elements in the distribution).

The mapping technique, whichever form of mapping table is used, preferably defines a one-to-one mapping: \hat{x}→θ. If the tabulated measurement values of the mapping table do not comprise measurement value sub-ranges, or ‘bins’, then the mapping technique may comprise searching the mapping table to identify the tabulated measurement value closest (in value) to the a given measurement value, x₁, at hand (i.e. find \hat{x}≈xᵢ) and then mapping the given measurement value, xᵢ, to a measurand value (θ), as follows:

$$\hat{x} \approx {x}_{i} \to {θ}_{i}$$

A more refined method may comprise identifying the two closest tabulated measurement values (i.e. upper and lower values: \hat{x}u, \hat{x}_{L}), between which the given measurement value falls, that are closest in value to the given measurement value, xᵢ, such that: \hat{x}_{L}<xᵢ<\hat{x}_{U}. The method may comprise mapping each of the two closest tabulated measurement values to a respective measurand value (i.e. upper and lower values: \hat{x}_{U}→θ_{U}, \hat{x}_{L}→θ_{L}) and subsequently interpolating between the two respective measurand values to calculate an interpolated measurand value (\tilde{θ}ᵢ) more accurately mapped to the given measurement value, xᵢ. As an example, a linear interpolation may be employed whereby:

$${x}_{i} \to {\tilde{θ}}_{i} = \frac{{θ}_{U} - {θ}_{L}}{{\hat{x}}_{U} - {\hat{x}}_{L}} ( {x}_{i} - {\hat{x}}_{L} ) + {θ}_{L}$$

Other interpolation methods may be used, as would be readily available to the skilled person.

The mapping table may also comprise a plurality of tabulated values for the distribution (frequency or probability distribution) of the tabulated measurement values (\hat{x}) as generated by (or associated with) the reference measurement apparatus. This distribution may be used as a reference Prior function (\hat{ƒ}_{θ}(θ)) for generating a Prior distribution, ƒ_{Θ}(θ), for the measurand (θ), as follows:

$${f}_{Θ} ( θ ) = {\hat{f}}_{Θ} ( {θ}_{i} ) .$$

This allows the reference measurement apparatus to provide a “ground truth” set of measurement values and a distribution for them, from which to generate a Prior distribution, ƒ_{Θ}(θ), for use in calculating the Posterior function for the measurement apparatus at hand. If interpolation of measurement values occurs, as described above, then interpolation of corresponding values of the reference Prior function (\hat{ƒ}_{θ}(θ)) may also be done for generating a Prior distribution, ƒ_{Θ}(θ), for the measurand (θ). As an example, a linear interpolation may be employed whereby:

$${\hat{f}}_{Θ} ( {\tilde{θ}}_{i} ) = \frac{{{\hat{f}}_{Θ} ( {θ}_{U} ) - {\hat{f}}_{Θ} ( {θ}_{L} )}_{}}{{θ}_{U} - {θ}_{L}} ( {\tilde{θ}}_{i} - {θ}_{L} ) + {\hat{f}}_{Θ} ( {θ}_{L} )$$

Other interpolation methods may be used, as would be readily available to the skilled person.

If the mapping table tabulated does comprise measurement value sub-ranges, or ‘bins’, then a given tabulated measurement value ‘bin’ may be define by a sub-range comprising upper and lower values: \hat{x}_{U}, \hat{x}_{L}, between which the given measurement value falls such that: \hat{x}_{L}<xᵢ<\hat{x}_{U}. The mapping technique may comprise searching the mapping table to identify the tabulated measurement value ‘bin’ within which a given measurement value, xᵢ, at hand falls such that: \hat{x}_{L}<xᵢ<\hat{x}_{U}, and then mapping the given measurement value, xᵢ, to a measurand value (θ), as follows:

$$\hat{x} \approx {x}_{i} \to {θ}_{i} .$$

The mapping table may also comprise a plurality of tabulated values for the distribution (frequency or probability distribution) of the tabulated measurement values occurring within the sub-ranges, or ‘bins’, for the measurement values generated by (or associated with) the reference measurement apparatus. This distribution may be used as a reference Prior function (\hat{ƒ}_{θ}(θ)) for generating a Prior distribution, ƒ_{Θ}(θ), for the measurand (θ), as follows:

$${f}_{Θ} ( θ ) = {\hat{f}}_{Θ} ( {θ}_{i} ) .$$

This also allows the reference measurement apparatus to provide a “ground truth” set of measurement values and a distribution for them, from which to generate a Prior distribution, ƒ_{Θ}(θ) for the measurand.

The reference measurement apparatus may be another instance of (i.e. of the same construction, structure and properties, e.g. substantially identical) the measurement apparatus by which the measurements at hand are generated. This reference measurement apparatus may be a ‘trusted source’ of a “ground truth” set of measurement values.

Alternatively, the reference measurement apparatus may be the self-same measurement apparatus by which the measurements at hand are generated. The mapping technique may then comprise storing in a memory successive measurement values (xᵢ) contemporaneously generated by the measurement apparatus thereby to update and extend the contents of the memory with each new measurement value generated by the measurement apparatus. The mapping technique may comprise generating a distribution, F(x), (e.g. a frequency or probability distribution) of the aggregation of measurement values (xᵢ) stored in the memory. The mapping technique may comprise estimating an analytical form for the distribution, F(x), of the aggregation of measurement values (xᵢ) stored in the memory. The estimated analytical form for the distribution (F(x)) may be used as the reference Prior function (\hat{ƒ}_{θ}(0)). The mapping technique may comprise updating the distribution (F(x)) in response to an update (i.e. a new measurement value) extending the contents of the memory. The continual updating of the aggregate of measurement values means that the distribution (F(x)) is also continually updated. The greater the number of measurement values that are aggregated in the memory, then the greater is the accuracy with which the updated distribution (F(x)) able to represent a “ground truth” set of measurement values and a distribution for them, from which to generate a Prior distribution, ƒ_{Θ}(θ). This is because the ‘signal-to-noise’ ratio of the updated distribution will tend to increase as the number of measurement data items in the aggregation increases. In other words, and underlying “ground truth” will tend to emerge in the updated distribution (F(x)) and this emergent distribution may be used as the reference Prior function (\hat{ƒ}_{θ}(O)). In this way, the self-same measurement apparatus may serve as its own reference measurement apparatus so that the distribution (F(x)) of the prior measurements of the self-same measurement apparatus may serve as the reference Prior function (\hat{ƒ}_{θ}(θ)). The one-to-one mapping: \hat{x}→θ described above may then be conducted based on the distribution (F(x)) of the prior measurements. For example, each tabulated measurement value (\hat{x}) in the mapping table may map to a corresponding value (e.g. the same measurement value) of the distribution (F(\hat{x})) of the prior measurements, with the result that the Prior distribution (ƒ_{Θ}(θ)) is obtained from the relation:

$${f}_{Θ} ( θ ) = {\hat{f}}_{Θ} ( {θ}_{i} ) = F ( \hat{x} )$$

The mapping technique may include applying an averaging process, or smoothing process, to the distribution (F(x)) of the prior measurements to reduce noise levels within the distribution. This may better reveal the underlying “ground truth” Prior distribution e.g. if the reference Prior function (\hat{ƒ}_{θ}(θ)) is numerical in form and not in an analytical form as described above.

The step of providing a Likelihood function (ƒₓ(x|θ)) defining a likelihood for the measurement values (x) associated with a given measurand (θ), may comprise providing a numerical or mathematical model for the measurement ‘noise’ of the measurement apparatus. This may comprise providing an analytical function which provides a value of a probability that the measurement apparatus will output a measurement value (x) in response to the measurand (i.e. the ‘input’ to the measurement apparatus) of a specified measurand value (θ). The analytical function may be selected from any suitable ‘named’ probability distribution such as, but not limited to, any of: Gaussian, Poisson, Log-Normal, Binomial, Beta-distribution. The mathematical model for the measurement ‘noise’ of the measurement apparatus may be numerical in form and may comprise a numerical function generated by a computer simulation such as a Monte Carlo statistical simulation, or other statistical or numerical simulation by which the ‘noisy’ response of the measurement apparatus may be modelled.

With the Likelihood function and a Prior distribution to hand, the method may calculate the posterior function, according to Bayes Rule, and output the result as the probability that a measurement value (x) is the result of a given value of the measurand (θ). The method may comprise updating the plurality of measurement values as and when a new measurement value is generated by the measurement apparatus, updating the mapping process described above using the updated plurality of measurement values, and therewith calculating an updated Prior function, then calculating and outputting an updated value for the Posterior function based on the updated Prior function, so as to provide an updated probability that a measurement value (x) is the result of a given value of the measurand (θ). This updating may be done continuously over a period of time, or periodically at selected time intervals.

In a further aspect, the invention may provide a computer programmed with a computer program which, when executed on the computer, implements the method described above in the third aspect of the invention. In a yet further aspect, the invention may provide a computer program product comprising a computer program which, when executed on a computer, implements the method described above in the third aspect of the invention. The method may be implemented using digital logic apparatus/circuits not comprising a programmable processor, such as dedicated fixed-function logic, or the method may be implemented using a mixture of digital logic and analogue circuits. The invention may comprise digital logic apparatus/circuits configured to implement this method.

In a fourth aspect, the invention may provide an apparatus for providing a probability (ƒ_{Θ}(θ|x)) that a given measurement value(s) (x) made by a measurement apparatus is the result of a given value of the measurand (θ) being measured, the apparatus comprising a computer configured to:
receive a plurality of measurement values (x);
map (ƒ_{x,Θ}(x,θ)) the plurality of measurement values (x) to a corresponding plurality of measurand values (θ);
generate a Prior distribution (ƒ_{Θ}(θ)) for the measurand (θ) based on the mapping (ƒ_{x,Θ}(x,θ)) of measurement values (x) to measurand values (θ);
provide a Likelihood function (ƒₓ(x|θ)) defining a likelihood for the measurement values (x) associated with a given measurand (θ);
calculate a Posterior function (ƒ_{Θ}(θ|x)) for the measurement using the Prior distribution and the Likelihood function according to a Bayes-Laplace rule;
output the value of the Posterior function as a probability that a measurement value(s) (x) made by the measurement apparatus is the result of a given value of the measurand (θ) measured thereby.

The apparatus may comprise the measurement apparatus (e.g. a sensor) configured in communication with the computer for providing measurement values to the computer. The apparatus may comprise a memory unit configured in communication with the measurement apparatus for receiving measurement values from the measurement apparatus, wherein the computer comprises a processor configured in communication with the memory unit for retrieving the received measurement values for processing to provide the value of the Posterior function.

The computer may be configured to calculate the Posterior function as including a multiple product of the Prior distribution for a given measurand value and the respective Likelihood functions corresponding to each respective one of a plurality of the measurement values and the given measurand value. The computer may be configured to calculate the Posterior function as including a sum, over all measurand values, of the separate products of the Prior distribution for a measurand value and the Likelihood function respect of that measurand value and all of the plurality of measurement values. The Posterior function may be calculated as the multiple product divided by the sum. The computer may be configured to calculate a Posterior function (ƒ_{Θ}(θ|x)) for the measurement using the following Posterior function:

$${f}_{Θ} ( θ \vert x ) = \frac{{\prod }_{\{ {x}_{1} , {x}_{2} , … , {x}_{N} \}} {f}_{X} ( x \vert θ ) {f}_{Θ} ( θ )}{{\sum }_{θ ∈ 𝒟 ( Θ )} {f}_{X} ( x \vert θ ) {f}_{Θ} ( θ )}$$

The computer may be configured to calculate the Posterior function in respect of a single measurement value (x), in which case the quantity (x) in the Posterior function ƒ_{Θ}(θ|x) is simply a single scalar value (i.e. ƒ_{Θ}(θ|x)=ƒ_{Θ}(θ|x); N=1). Alternatively, the computer may be configured to calculate the Posterior function in respect of a plurality of measurement values (x₁, x₂, . . . , x_{N}), in which case the quantity (x) in the Posterior function ƒ_{Θ}(θ|x) is a vector of N separate measurement values, (xᵢ), each of which is itself one separate scalar measurement value (i.e. the vector of N measurements: x=(x₁, x₂, . . . , x_{N})^{T}) The computer may be configured to map (ƒ_{x,Θ}(x,θ)) the plurality of measurement values (x) to a corresponding plurality of measurand values (θ), by any one of several optional mapping techniques, discussed below.

According to one mapping technique, the computer may be configured to provide a mapping table (e.g. a lookup table LUT) comprising the plurality of tabulated measurement values (\hat{x}) obtained from a reference measurement apparatus and comprising a corresponding plurality of measurand values (θ) in which each table entry for a given tabulated measurement value corresponds to one unique tabulated entry for a measurand value. Alternatively, more preferably, the computer may be configured to provide a mapping table (e.g. a lookup table LUT) comprising the plurality of tabulated measurement value sub-ranges, or ‘bins’, (\hat{x}) extending over a range of all of the measurements obtained from a reference measurement apparatus and comprising a corresponding plurality of measurand value sub-ranges, or ‘bins’, (θ) in which each table entry for a given tabulated measurement value bin corresponds to one unique tabulated entry for a measurand value bin. This range of all of the measurements obtained from a reference measurement apparatus may be divided into successive measurement sub-ranges, or ‘bins’, preferably of equal size, in ascending order of measurement value.

The mapping technique of the computer, whichever form of mapping table is used, preferably defines a one-to-one mapping: \hat{x}→θ. If the tabulated measurement values of the mapping table do not comprise measurement value sub-ranges, or ‘bins’, then the computer may be configured to search the mapping table to identify the tabulated measurement value closest (in value) to the a given measurement value, xᵢ, at hand (i.e. find \hat{x}≈xᵢ) and then mapping the given measurement value, xᵢ, to a measurand value (θ), as follows:

$$\hat{x} \approx {x}_{i} \to {θ}_{i}$$

A more refined method the computer may be configured to identify the two closest tabulated measurement values (i.e. upper and lower values: \hat{x}_{U}, \hat{x}_{L}), between which the given measurement value falls, that are closest in value to the given measurement value, xᵢ, such that: \hat{x}_{L}<xᵢ\hat{x}_{U}. The computer may be configured to map each of the two closest tabulated measurement values to a respective measurand value (i.e. upper and lower values: \hat{x}_{U}→θ_{U}, \hat{x}_{L}→θ_{L}) and subsequently to interpolate between the two respective measurand values and calculate an interpolated measurand value (\tilde{θ}ᵢ) more accurately mapped to the given measurement value, xᵢ. As an example, a linear interpolation may be employed whereby:

$${x}_{i} \to {\tilde{θ}}_{i} = \frac{{θ}_{U} - {θ}_{L}}{{\hat{x}}_{U} - {\hat{x}}_{L}} ( {x}_{i} - {\hat{x}}_{L} ) + {θ}_{L}$$

Other interpolation methods may be used, as would be readily available to the skilled person.

The mapping table of the computer may also comprise a plurality of tabulated values for the distribution (frequency or probability distribution) of the tabulated measurement values (\hat{x}) as generated by (or associated with) the reference measurement apparatus. This distribution may be used as a reference Prior function (\hat{ƒ}_{Θ}(θ)) for generating a Prior distribution, ƒ_{Θ}(θ), for the measurand (θ), as follows:

$${f}_{Θ} ( θ ) = {\hat{f}}_{Θ} ( {θ}_{i} ) .$$

This allows the reference measurement apparatus to provide a “ground truth” set of measurement values and a distribution for them, from which to generate a Prior distribution, ƒ_{Θ}(θ), for use in calculating the Posterior function for the measurement apparatus at hand. If interpolation of measurement values occurs, as described above, then the computer may be configured to perform interpolation of corresponding values of the reference Prior function (\hat{ƒ}_{Θ}(θ)) for generating a Prior distribution, ƒ_{Θ}(θ), for the measurand (θ). As an example, a linear interpolation may be employed whereby:

$${\hat{f}}_{Θ} ( {\tilde{θ}}_{i} ) = \frac{{\hat{f}}_{Θ} ( {θ}_{U} ) - {\hat{f}}_{Θ} ( {θ}_{L} )}{{θ}_{U} - {θ}_{L}} ( {\tilde{θ}}_{i} - {θ}_{L} ) + {\hat{f}}_{Θ} ( {θ}_{L} )$$

Other interpolation methods may be used, as would be readily available to the skilled person.

If the mapping table tabulated does comprise measurement value sub-ranges, or ‘bins’, then the computer may be configured to define each one of the plurality of tabulated measurement value ‘bins’ by a sub-range comprising upper and lower values: \hat{x}_{U}, \hat{x}_{L}, between which a given measurement value may fall such that: \hat{x}_{L}<xᵢ<\hat{x}_{U}. The computer may be configured to perform the mapping technique by searching the mapping table to identify the tabulated measurement value ‘bin’ within which a given measurement value, xᵢ, at hand falls such that: \hat{x}_{L}<xᵢ<\hat{x}_{U}, and then map the given measurement value, xᵢ, to a measurand value (θ) associated with that bin, as follows:

$$\hat{x} \approx {x}_{i} \to {θ}_{i} .$$

The computer may be configured to provide the mapping table comprising a plurality of tabulated values for the distribution (frequency or probability distribution) of the tabulated measurement values occurring within the sub-ranges, or ‘bins’, for the measurement values generated by (or associated with) the reference measurement apparatus. This distribution may be used, by the computer, as a reference Prior function (\hat{ƒ}_{Θ}(θ)) for generating a Prior distribution, ƒ_{Θ}(θ), for the measurand (θ), as follows:

$${f}_{Θ} ( θ ) = {\hat{f}}_{Θ} ( {θ}_{i} ) .$$

This also allows the reference measurement apparatus to provide a “ground truth” set of measurement values and a distribution for them, from which to generate a Prior distribution, ƒ_{Θ}(θ) for the measurement apparatus at hand.

The reference measurement apparatus may be another instance of (i.e. of the same construction, structure and properties, e.g. substantially identical) the measurement apparatus by which the measurements at hand are generated. This reference measurement apparatus may be a ‘trusted source’ of a “ground truth” set of measurement values.

Alternatively, the reference measurement apparatus may be the self-same measurement apparatus by which the measurements at hand are generated. The computer may be configured to perform the mapping technique by storing in a memory successive measurement values (xᵢ) contemporaneously generated by the measurement apparatus thereby to update and extend the contents of the memory with each new measurement value generated by the measurement apparatus. The computer may be configured to perform the mapping technique by generating a distribution, F(x), (e.g. a frequency or probability distribution) of the aggregation of measurement values (xᵢ) stored in the memory. The computer may estimate an analytical form for the distribution, F(x), of the aggregation of measurement values (xᵢ) stored in the memory. The estimated analytical form for the distribution (F(x)) may be used, by the computer, as the reference Prior function (\hat{ƒ}_{Θ}(θ)). The computer may update the distribution (F(x)) in response to an update (i.e. a new measurement value) extending the contents of the memory. The one-to-one mapping: \hat{x}→θdescribed above may then be performed, by the computer, based on the distribution (F(x)) of the prior measurements. The computer may be configured such that each tabulated measurement value (\hat{x}) in the mapping table maps to a corresponding value (e.g. the same measurement value) of the distribution (F(\hat{x})) of the prior measurements, with the result that the Prior distribution (ƒ_{Θ}(θ)) is obtained from the relation:

$${f}_{Θ} ( θ ) = {\hat{f}}_{Θ} ( {θ}_{i} ) = F ( \hat{x} )$$

The computer may be configured to apply an averaging process, or smoothing process, to the distribution (F(x)) of the prior measurements to reduce noise levels within the distribution.

The computer may be configured to provide a Likelihood function (ƒₓ(x|θ)) by providing a numerical or mathematical model for the measurement ‘noise’ of the measurement apparatus. This may comprise providing an analytical function. The analytical function may be selected from any suitable ‘named’ probability distribution such as, but not limited to, any of: Gaussian, Poisson, Log-Normal, Binomial, Beta-distribution. The numerical model may comprise a numerical function generated by a computer simulation such as a Monte Carlo statistical simulation, or other statistical or numerical simulation by which the ‘noisy’ response of the measurement apparatus may be modelled.

The computer may be configured to update the plurality of measurement values as and when a new measurement value is generated by the measurement apparatus, and update the mapping process described above using the updated plurality of measurement values, and therewith calculate an updated Prior function, then calculate and output an updated value for the Posterior function based on the updated Prior function. This provides an updated probability that a measurement value (x) is the result of a given value of the measurand (θ). This updating may be done, by the computer, continuously over a period of time, or periodically at selected time intervals.

In a further aspect, the invention may provide a computer programmed with a computer program which, when executed on the computer, implements the method described above in the third aspect of the invention. The invention may comprise the computer and the measurement apparatus by which the aforementioned measurement values are generated. The measurement apparatus may be part of a quantum computer and may be configured to perform measurements of one or more qubits (e.g. within a quantum register). In a yet further aspect, the invention may provide a computer program product comprising a computer program which, when executed on a computer, implements the method described above in the third aspect of the invention.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In another aspect, or in combination with any aspect disclosed herein, the invention may concern methods and apparatus for deterministically re-quantising representations of uncertainty (e.g., histograms or cumulative density functions) to reduce the amount of overall energy or average power dissipation needed for transmitting those representations over transmission interfaces (e.g. serial I/O interfaces). This may be implemented, for example, in a computation and sensing system. The invention may reduce the amount of energy needed for transmitting the representations over communication interfaces where different bit sequences lead to different required energy costs for transmission overall or different energy costs per second (average power dissipation). One example of such communication interfaces are the electrical interfaces between sensor integrated circuits mounted on a printed circuit board such as the I2C, I3C, MIPI CSI, and SPI standard interfaces to sensors.

The invention may also be applied to communication interfaces of other modalities, such as optical interconnects, where the energy for transmitting a bit sequence can depend on the amount of time for which an energy source such as a laser or LED is on and could therefore depend on the number of 1s versus 0s in the serialized binary representation of the data being transmitted.

The invention is applicable to any systems that transmit, store, or perform computations on representations of uncertainty. Such systems include Bayesian machine learning systems whose outputs are pairs of predictions and their associated uncertainties. Applicable systems also include the results of quantum computations when the measurement of qubit wave functions result in a classical information representation of bit values and their associated probabilities.

Because representations of uncertainty require much more data than traditional representations of point values, the invention may significantly reduce the overhead associated with computing and storing natively with representations of uncertainty. Sensors such as LIDAR generate data at high data rates, easily 10 Gb/s per ADC channel, when delivering time-series data with full-waveform digitization of the signals coming out of photodetectors, which is essential for achieving improved LIDAR range. Because of the nature of the LiDAR sensing systems (e.g. a photodetector feeding a trans-impedance amplifier (TIA)), the data from LiDAR sensors are both noisy of a high data rate.

In a fifth aspect, the invention may provide a computer-implemented method for encoding a sample set of data (e.g. measurement data from a measurement device) for transmission from a transmitter, the method comprising:
obtaining a sample set of data (e.g. comprising measurement data elements generated by the measurement device);
comparing the distribution of the obtained sample set to a plurality of different reference distributions thereby to determine a plurality of difference values each quantifying a difference between the distribution of the obtained sample set and a respective one of the reference distributions;
determining, for each reference distribution, whether the difference value associated therewith is less than a threshold difference value, thereby satisfying a first condition;
determining, for each reference distribution satisfying the first condition, a respective value of a cost function quantifying an energy requirement to transmit the reference distribution via the transmitter, and determining for the obtained sample set a value of the cost function quantifying an energy requirement to transmit the obtained sample set via the transmitter, and determining for each reference distribution whether the cost function value associated therewith is less than the cost function value associated with the obtained sample set, thereby satisfying a second condition;
selecting, from amongst the reference distributions satisfying the second condition, the reference distribution for which has the lowest cost function value, thereby satisfying a third condition;
using parameters defining the selected reference distribution satisfying the third condition for transmission from the transmitter as an encoded sample set approximating the obtained sample set of data.

In this way, the invention permits the replacement of a distribution of a plurality of data (e.g. measurement data items), in a sample set of data (e.g. measurement data), with a set of one or more parameters defining an approximate representation of the data distribution (i.e. the selected reference distribution) for use in transmission from the transmitter. The data required to define the approximate representation may be significantly less than the data contained in the sample set of measurement data, or the transmission energy cost for transmitting the reference distribution may be smaller than the energy required for transmitting the sample set of data (e.g. measurement data) or a distribution representing it, even though the reference distribution might constitute more data.

The reference distributions may comprise one or more so-called ‘named’ distributions including, but not limited to, the following: Normal; Log-Normal; Gaussian; Poisson, Binomial, Beta etc. Each of these distributions may be defined by a small number of parameters. For example, the Normal distribution, and the Log-Normal distribution may be defined by a pair of values (μ, σ): μ=the mean of the distribution; σ=the variance of the distribution. For example, the Poisson distribution may be defined by a single number (μ): μ=the mean of the distribution. The reference distributions may comprise one or more distributions of any suitable type available to the skilled person which are defined by any number of statistical parameters including, but not limited to, one or more moments of the distribution. Examples of statistical ‘moments’ include: First Moment (i.e. the mean of the distribution); Second Moment (i.e. the variance of the distribution); Third Moment (i.e. the kurtosis of the distribution); Fourth Moment etc. etc. The reference distributions may comprise one or more distributions of any suitable type available to the skilled person which are defined by any number of statistical parameters including, but not limited to: a value defining the number of data elements in the sample sat of data; a value defining a value/position (or relative position) of one, some or each of a plurality of data elements in the distribution. By replacing multiple data values with just one or a few parameters defining an approximation of the distribution, for representing the data in a transmission, one may reduce transmission energy costs. The energy cost may also be reduced even though its representation contains more data, if the reference distribution contains data that causes a transmission medium/means to require less power.

The invention is relevant where the re-quantising induces a bounded change in the properties of the uncertainty representation (e.g., a bound on the histogram distance or on the Kullback-Leibler (K-L) divergence between the original and re-encoded representation). The step of comparing the distribution of the obtained sample set (e.g. denoted: ‘s’) to a plurality of different reference distributions (e.g. denoted: ‘t’), may comprise determining difference values (D(s,t)) as between ‘s’ and all available ‘t’ distributions. The difference value may be a Kullback-Leibler divergence value, or it may be a Wasserstein distance. Any other suitable metric appropriate for defining a difference between two statistical distributions may be used, as would be readily apparent to the skilled person.

The step of determining, for each reference distribution ‘t’, whether the difference value D(s,t) associated therewith is less than a threshold difference value, d, thereby satisfying a first condition:

$$D ( s , t ) < d$$

may include excluding each reference distribution ‘t’ producing a value of D(s,t) that is too high (i.e. D(s,t)>d). In doing so, the method excludes from consideration all of those reference distributions that are ‘too different’ for use as an acceptable approximation to the distribution of the data within the sample set. The value of the threshold difference, d, may be set by the user as appropriate to the needs of the user so that the threshold difference value may be lower if a reference distribution ‘t’ is required to provide a very good approximation, but may be higher if a reference distribution ‘t’ is required to provide a lower level/degree of approximation.

The step of determining, for each reference distribution ‘t’ satisfying the first condition, whether the cost function value, #_{δ}(t), associated with each such reference distribution ‘t’ is less than the cost function value, #_{δ}(s), associated with the obtained sample set (the second condition), may ensure that the transmission ‘cost’ is improved sufficiently enough by the remaining options for reference distributions ‘t’, according to:

$${\#}_{δ} ( t ) \leq {\#}_{δ} ( s )$$

The step of selecting, from amongst the reference distributions satisfying the second condition, the reference distribution which has the lowest cost function value (the third condition) ensures that the transmission ‘cost’ for the finally-selected reference distribution ‘t’ provides the best improvement available from the remaining options for reference distributions ‘t’ that satisfy the second condition. This may be implemented according to:

$${\#}_{δ} ( t ) \leq {\#}_{δ} ( i ) , ∀ i ∈ 𝔻$$

Here the set [symbol] is the set of all reference distributions ‘t’ that satisfy the second condition. The finally-selected reference distribution ‘t’ satisfying this condition may then be deemed ready to use in transmission from the transmitter as an encoded sample set approximating the obtained sample set of data.

The method may include transmitting the encoded sample set of measurement data by transmitting information defining the finally-selected reference distribution ‘t’. This may comprise transmitting parameter values defining the finally-selected reference distribution ‘t’. That is to say, the encoded sample set of measurement data may be transmitted in place of the sample set of measurement data.

In a sixth aspect, the invention may provide an apparatus configured to encode a sample set of data (e.g. measurement data from a measurement device) for transmission from a transmitter, the apparatus comprising:
a memory unit for receiving an obtained sample set of data (e.g. comprising measurement data elements generated by the measurement device);
a processor unit configured to implement the following steps:
   comparing the distribution of the obtained sample set to a plurality of different reference distributions thereby to determine a plurality of difference values each quantifying a difference between the distribution of the obtained sample set and a respective one of the reference distributions;
   determining, for each reference distribution, whether the difference value associated therewith is less than a threshold difference value, thereby satisfying a first condition;
   determining, for each reference distribution satisfying the first condition, a respective value of a cost function quantifying an energy requirement to transmit the reference distribution via the transmitter, and determining for the obtained sample set a value of the cost function quantifying an energy requirement to transmit the obtained sample set via the transmitter, and determining for each reference distribution whether the cost function value associated therewith is less than the cost function value associated with the obtained sample set, thereby satisfying a second condition;
   selecting, from amongst the reference distributions satisfying the second condition, the reference distribution for which has the lowest cost function value, thereby satisfying a third condition;
an output unit configured to output to the transmitter parameters defining the selected reference distribution satisfying the third condition for transmission from the transmitter as an encoded sample set approximating the obtained sample set of data.

The processor unit may be configured to implement the step of comparing the distribution of the obtained sample set (e.g. denoted: ‘s’) to a plurality of different reference distributions (e.g. denoted: ‘t’), by determining difference values (D(s,t)) as between ‘s’ and all available ‘t’ distributions.

The processor unit may be configured to implement the step of determining, for each reference distribution ‘t’, whether the difference value D(s,t) associated therewith is less than a threshold difference value, d, thereby satisfying a first condition:

$$D ( s , t ) < d$$

by excluding each reference distribution ‘t’ producing a value of D(s,t) that is too high (i.e. D(s,t)>d). The processor unit may be configured to implement the step of determining, for each reference distribution ‘t’ satisfying the first condition, whether the cost function value, #_{δ}(t), associated with each such reference distribution ‘t’ is less than the cost function value, #_{δ}(s), associated with the obtained sample set (the second condition), according to:

$${\#}_{δ} ( t ) \leq {\#}_{δ} ( i ) , ∀ i ∈ 𝔻$$

The processor unit may be configured to implement the step of selecting, from amongst the reference distributions satisfying the second condition, the reference distribution which has the lowest cost function value (the third condition) according to:

$${\#}_{δ} ( t ) \leq {\#}_{δ} ( i ) , ∀ i ∈ 𝔻$$

Here the set [symbol] is the set of all reference distributions ‘t’ that satisfy the second condition. The finally-selected reference distribution ‘t’ satisfying this condition may then be output to the transmitter for transmission from the transmitter as an encoded sample set approximating the obtained sample set of data.

The apparatus may include the transmitter unit. The transmitter unit may be configured to transmit parameter values defining the finally-selected reference distribution ‘t’.

In a further aspect, the invention may provide a computer programmed with a computer program which, when executed on the computer, implements the method described above in the fifth aspect of the invention. In a yet further aspect, the invention may provide a computer program product comprising a computer program which, when executed on a computer, implements the method described above in the fifth aspect of the invention. The method may be implemented using digital logic apparatus/circuits not comprising a programmable processor, such as dedicated fixed-function logic, or the method may be implemented using a mixture of digital logic and analogue circuits. The invention may comprise digital logic apparatus/circuits configured to implement this method.

In other aspects, either separately or in conjunction with any other aspect herein, the invention may concern the following aspects. In other words, any one or more of the aspects described below may be considered as applying separately from, or in combination with, any of the aspects described above. For example, the apparatus described above may comprise the apparatus described below, and similarly so for the methods described above and the methods described below.

In a seventh aspect, the invention may provide a computer-implemented method for encoding a sample set of data (e.g. measurement data from a measurement device) for transmission in a signal from a transmitter to a receiver, the method comprising:
obtaining a sample set of data (e.g. comprising measurement data elements generated by the measurement device);
determining a distribution of the sample set of data;
generating a binary representation of the distribution;
providing a plurality of candidate binary representations of the distribution each corresponding to said binary representation as modified to comprise a respective one or more bit errors predicted to be made by the receiver upon receipt of a signal that is modulated by the transmitter according to a corresponding candidate modulation to convey the binary representation with lower signal transmission energy consumption relative to transmission without the candidate modulation;
for each of the candidate binary representations:
   providing a reconstructed distribution of the sample set of data reconstructed according to the candidate binary representation; and,
comparing the distribution of the sample set to the reconstructed distribution thereby to determine a difference value quantifying a difference between the distribution of the sample set and the reconstructed distribution;
   the method subsequently comprising selecting a candidate binary representation for which the difference value is less than a pre-set threshold difference value, and controlling the transmitter to generate a signal according to the corresponding candidate modulation thereby transmitting the distribution from the transmitter to the receiver.

In this way, the invention may identify a candidate modulation to use at the transmitter (i.e. corresponding to the selected candidate binary representation) when applying a modulation to appropriate portions of an analogue signal (‘signal bits’) used to represent bits of information (‘data bits’) passed to the transmitter for transmission. Thus, the final physical modulation is done not at the ‘data bit’ level within the information itself, but at the ‘signal bit’ level within the communications channel (e.g. modulating the drive voltage (V) of a diode laser transmitting ‘signal bits’ optically). The computer may perform the task of identifying a ‘candidate’ binary representation (e.g. item “s′ ” of FIG. 10). It may then send an instruction conveying to the transmitter to instruct the transmitter on what modulation it should apply to ‘signal bits’ (e.g. item “[S']” of FIG. 10) according to the binary representation. This modulation generates a transmission signal conveying the information defined by the original ‘data bits’ (e.g. item “s” of FIG. 10) that the transmitter receives from the computer. The selected candidate binary representation is thereby used to control a communication channel of the transmitter (e.g. at the transducer for generating the physical signal being transmitted), and not to the actual ‘data bits’ of the information.

The method may find the ‘best’ candidate modulation encoding which balances the need to reduce the transmission ‘cost’ enough, while not incurring unacceptable bit errors at the receiver. The balance is struck by finding which ‘signal bit’ modulations to apply at the transmitter (i.e. at its transducer) when generating a transmitted signal to convey the binary representation of the data (i.e. to which of the ‘signal bits’ and by how much), with the expectation that some bit errors will occur at the receiver, when the receiver receives the ‘signal bits’ and converts them in to a binary representation (data bits) but intelligently accepting bit errors in data bits that do not have a significant impact on the overall accuracy of the resulting data interpreted by the receiver.

In a further optional feature of the method, the step of comparing candidate distributions to the originally determined distribution aims to find the candidate that provides the appropriate balance between the gains to be made in reducing signal transmission cost (e.g. energy cost) and loss of information due to the degree of the approximation. The difference value may be selected as appropriate based on these considerations.

In a further optional feature of the method, the step of determining a distribution of the sample set of data may comprise determining parameters of a probability distribution for the data within the sample set of data. The determining of a distribution may comprise calculating data which contains information defining the distribution of the sample set of data. The information defining the distribution of the sample set may comprise information defining the parameters of a distribution permitting the distribution to be reconstructed based solely on those parameters. Examples of parameters of a distribution include, but are not limited to: the range (or ‘support’) of the data values covered by the distribution (e.g. the positions of the uppermost and lowermost data values in the distribution, or ‘bins’ in a histogram); the positions of data elements (e.g. their values) in the range of data values covered by the distribution; the divisions of the range of data values covered by the distribution (e.g. the widths of the ‘bins’ in a histogram); the frequency (or probability) values associated with data values occurring within range of values, or associated with the divisions of the range (e.g. the ‘heights’ of the bars in a histogram). Other examples of parameters of a distribution include, but are not limited to: the type/name of a ‘named’ or pre-defined distribution (e.g. ‘Normal’, ‘Poisson’ etc.); the variables that uniquely define the ‘named’ or pre-defined distribution (e.g. mean, variance, a set of moments of the distribution, etc.).

In a further optional feature of the method, the step of generating of a binary representation may comprise generating a bit string of binary data which contains the information defining the distribution of the sample set of data.

References herein to modulating or modulation, may be considered to include a reference to changing the size, value or magnitude of a quantity (e.g. a ‘signal bit’ value). The method may comprise generating a given candidate modulation by modulating/changing the value of the physical channel used to convey a signal bit in such a way as to reduce the amount of energy required by the transmitter to transmit that bit.

The method may comprise generating a given candidate modulation by modulating a given value of a physical channel used to convey a signal bit by reducing the value of the physical channel used to convey the bit if the bit has a bit value of 1 (one). For example, a bit value of one (1) at the physical channel may be modulated to become a bit value of less than one (e.g. 0.9).

In a further optional feature of the method, the method may comprise providing different candidate binary representations by modifying said binary representation to comprise different respective bit errors predicted to be made by the receiver upon receipt of a signal from the transmitter modulated according to the corresponding candidate modulation. For example, in one candidate, a first amount of bit errors may be predicted to occur to a given one or more bits of the candidate binary representation and, in another candidate, a second amount of bit errors (different to the first amount) may be predicted to occur to the same one or more bits of the candidate binary representation. The method may comprise applying different bit predicted amounts of bit errors to the bits of the candidate binary representation by applying, in one candidate, a given amount of predicted bit errors to a selected group of one or more bits of the candidate binary representation and applying, in another candidate, the same given amounts of bit errors to a different selected group of one or more bits (different to the first group) of the candidate binary representation. Two candidates may be ‘different’ in either one of, or both of, these ways.

In a further optional feature of the method, the step of providing a candidate binary representation of the distribution may comprise generating a plurality of candidate binary representations each of which corresponds to a respective one of a plurality different bit errors predicted to be made by the receiver. The method may include determining a plurality of reconstructed distributions of the sample set of data each of which is determined according to a respective one of the plurality of candidate binary representations. The method may include comparing the distribution of the sample set to each one of the plurality of reconstructed distributions thereby to determine a respective plurality of difference values quantifying a difference between the distribution of the sample set and a respective reconstructed distribution. The step of selecting a candidate binary representation may comprise selecting a candidate binary representation for which the difference value is less than a threshold difference value. In this way, the method may exclude candidate binary representations (signal bit modulation encodings) that have an unacceptably high probability of resulting in a reconstructed distribution, at the receiver, that is too different from the distribution of the received sample set.

In a further optional feature of the method, the method may include determining, for each candidate binary representation, a respective value of a cost function quantifying an energy requirement to transmit the binary representation via the transmitter according to the corresponding candidate modulation. The method may include determining for the obtained sample set a value of the cost function quantifying an energy requirement to transmit the binary representation of the distribution of the obtained sample set via the transmitter. The method may include determining for each candidate binary representation whether the cost function value associated therewith is less than the cost function value associated with the binary representation of the distribution of the obtained sample set, thereby satisfying a cost condition. The step of selecting a candidate binary representation, and its corresponding candidate modulation for transmission from the transmitter, may comprise selecting from amongst the candidate binary representations satisfying the cost condition, the candidate binary representation which has the lowest cost function value. This candidate modulation corresponding to the selected candidate binary representation may then be transmitted from the transmitter.

In the way, the method may include ensure the transmission ‘cost’ is improved enough by the remaining candidates. By using only the candidates passing the tests of:
(1) sufficiently low difference value;
(2) sufficiently low likelihood of incurring unacceptable bit errors at the receiver;
(3) sufficient reduction in transmission ‘cost’.

In a further optional feature of the method, the method may comprise providing a value for the probability (p) of a bit error, occurring at the receiver in respect of a respective signal bit in a given signal bit string defining a given candidate modulation, as predicted to be made by the receiver upon receipt of the candidate modulation from the transmitter. The value of the probability (p) may be provided by providing a Noise Model for the receiver device (i.e. considered as being a signal ‘sensor’ or measurement apparatus) which may be deemed to represent the distribution of induced bit error probabilities at the receiver. This Noise Model may be an analytical function, a numerical model (e.g. Monte Carlo simulation) or other mathematical model, pre-prepared and based either on a knowledge of the properties of the receiver (or of receivers of that class/type) or on assumed properties of the receiver (or of receivers of that class/type). As a simple example, the Noise Model may comprise any one or more of the so-called ‘named’ statistical distributions selected from, but not limited to: Normal; Log-Normal, Poisson, Binomial etc. etc. The Noise Model may take into account whether or not a signal error correction process is applied by the receiver to signals it receives, and it may take into account what the efficiency or performance of the error correction process applied. It will be appreciated that if the receiver applies an error correction process, then it is more likely to consistently interpret a modulated bit at the physical channel as being a bit value of one (1) if the modulated value of that bit is relatively close to the value of one (1), e.g. a bit value of 1 is modulated at the physical channel to a bit value of 0.9, but this is seen by the receiver as a bit ‘error’ and is ‘corrected’ to a value of 1 by the receiver.

In a further optional feature of the method, the method may comprise providing such a value for the probability (p) of a bit error at the receiver for each respective one of the signal bits in a given signal bit string defining a given candidate modulation. This may provide a distribution of induced (at the receiver physical channel) bit error probabilities. The step of generating a candidate binary representation of the distribution may comprise applying a bit error to a given bit of said binary representation according to the respective probability (p) of a bit error occurring for the given bit at the receiver. For example, a bit error may be applied if the respective probability is sufficiently high (p>threshold; e.g. threshold=0.5, or 0.6, or 0.7 etc.).

In a further aspect, the invention may provide a computer programmed with a computer program which, when executed on the computer, implements the method described above in any of the aspects of the invention. In a yet further aspect, the invention may provide a computer program product comprising a computer program which, when executed on a computer, implements the method described above in any of the aspects of the invention.

In a further aspect, the invention may provide an apparatus configured to implement the method described above, in any aspect of the invention. For example, in an aspect, the invention may provide an apparatus for encoding a sample set of measurement data (e.g. from a measurement device) for transmission from a transmitter to a receiver, the apparatus comprising:
a memory unit for receiving an obtained sample set of data (e.g. comprising measurement data elements generated by the measurement device);
a processor unit configured to implement the following steps:
obtain a sample set of data (e.g. comprising measurement data elements generated by the measurement device);
determine a distribution of the sample set of data;
generate a binary representation of the distribution;
provide a plurality of candidate binary representations of the distribution each corresponding to said binary representation as modified to comprise a respective one or more bit errors predicted to be made by the receiver upon receipt of a signal that is modulated by the transmitter according to a corresponding candidate modulation to convey the binary representation with lower signal transmission energy consumption relative to transmission without the candidate modulation;
for each of the candidate binary representations:
   provide a reconstructed distribution of the sample set of data reconstructed according to the candidate binary representation; and,
   compare the distribution of the sample set to the reconstructed distribution thereby to determine a difference value quantifying a difference between the distribution of the sample set and the reconstructed distribution;
the apparatus being configured to subsequently select a candidate binary representation for which the difference value is less than a pre-set threshold difference value, and controlling the transmitter to generate a signal according to the corresponding candidate modulation thereby transmitting the distribution from the transmitter to the receiver.

The apparatus may be configured to implement any one or more of the further optional features of the method described above.

In a further aspect, the invention may provide a computer programmed with a computer program which, when executed on the computer, implements the method described above in any aspect of the invention. The invention may comprise the computer and the measurement apparatus by which the aforementioned measurement values are generated. In a yet further aspect, the invention may provide a computer program product comprising a computer program which, when executed on a computer, implements the method described above in any aspect of the invention.

The invention includes the combination of the aspects and preferred features described except where such a combination is clearly impermissible or expressly avoided.

References herein to “sequential” may be considered to include a reference to forming or following in a logical order or sequence, such as an order in time or a temporal sequence.

References herein to “time series” may be considered to include a reference to a series of values of a quantity obtained at successive times, e.g. with equal or differing time intervals between them. This may comprise a sequence of data items that occur in successive order over some period of time.

References herein to “comparing” may be considered to include a reference to estimating, measuring, or noting the similarity or dissimilarity between items compared.

References herein to “threshold” may be considered to include a reference to a value, magnitude or quantity that must be equalled or exceeded for a certain reaction, phenomenon, result, or condition to occur or be manifested.

References herein to “distribution” in the context of a statistical data set (or a population) may be considered to include a reference to a listing or function showing all the possible values (or intervals) of the data and how often they occur. A distribution in statistics may be thought of as a function (empirical or analytical) that shows the possible values for a variable and how often they occur. In probability theory and statistics, a probability distribution may be thought of as the function (empirical or analytical) that gives the probabilities of occurrence of different possible outcomes for measurement of a variable.

### SUMMARY OF THE FIGURES

Embodiments and experiments illustrating the principles of the invention will now be discussed with reference to the accompanying figures in which:

FIG. 1 schematically shows a measurement apparatus according to an embodiment of the invention;

FIG. 2A schematically shows a processing of a set of measurements by the measurement apparatus of FIG. 1;

FIG. 2B schematically shows a series of sample sets of measurements made by the measurement apparatus of FIG. 1;

FIG. 3 shows a flow chart of an algorithm for processing of a set of measurements as illustrated in FIG. 2B;

FIG. 4 shows a graph of measured values output by a sensor subject to drift;

FIG. 5 schematically shows a process performed by the apparatus of FIG. 1;

FIG. 6 shows: (a) a 3D LiDAR depth image from a LiDAR sensor, (b): a 2D view of the 3D depth image (a) of the LiDAR sensor, (c) & (d): examples of quantified distance measurement uncertainty for two different distance-resolution modes of operation of a LiDAR sensor. The uncertainty of the depth measurement is often not Gaussian. it varies across pixels and LiDAR resolution modes, and it often has significant outliers (see (d));

FIG. 7 schematically shows a quantum computer and a distribution of the measured values of the register of qubits thereof.

FIG. 8 schematically shows a schematic representation of a timing diagram for a transmitter operating according to the I2C data transmission protocol;

FIG. 9 shows an example of encoding of an obtained sample set of data for transmission from a transmitter as an encoded sample set approximating the obtained sample set of data;

FIG. 10 shows an example of encoding of an obtained sample set of data for transmission from a transmitter as an encoded sample set of data.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

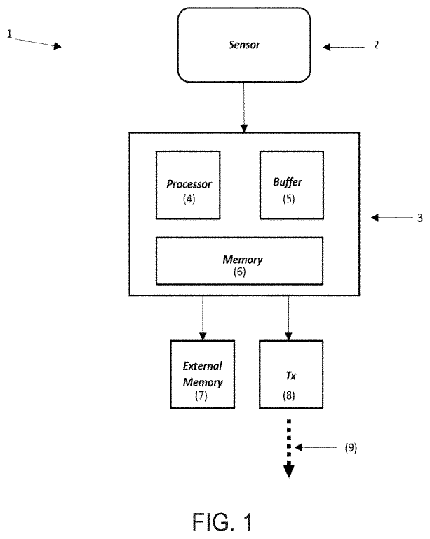

FIG. 1 shows a measurement apparatus 1 according to an embodiment of the invention. The measurement apparatus comprises a measurements device 2 in the form of a sensor unit (e.g. an accelerometer) configured to generate measurements of a pre-determined measurable quantity: a measurand (e.g. acceleration). The measurement 5 apparatus further includes a computer system 3 including a processor 4 in communication with a local buffer memory unit 5 and a local main memory unit 6. The computer system is configured to receive, as input, data from the sensor unit representing measurements of the measurand (i.e. acceleration), and to store the received measurements in the local main memory unit 6. The processor unit 4, in conjunction with the buffer memory unit 5, is configured to apply to the stored measurements a data processing algorithm configured for sampling the measurements from a sensor stored in main memory, so as to generate sample sets of measurements which each represent the uncertainty in measurements made by the sensor unit 2 while also representing the measurand as accurately as the sensor unit may allow.

This representation of uncertainty is achieved by adaptively generating the sample sets such that the distribution of measurement values within each of the sample sets represent the probability distribution of measurements by the sensor unit 2 while the measurand was substantially unchanging. The computer system is configured to store the sample sets, once generated, in its main memory 6 and/or to transmit the sample sets to an external memory 7 arranged in communication with the computer system, and/or to transmit via a transmitter unit 8 one or more signals 9 conveying one or more of the sample sets to a remote receiver (not shown). The signal may be transmitted wirelessly, fibre-optically or via other transmission means as would be readily apparent to the skilled person.

In other embodiments, the sensor unit is remote from the computer system 3, and the is configured to remotely transmit measurements (wirelessly or otherwise) to the computer system 3 which, in turn, is configured to wirelessly receive, as input, data from the sensor unit transmitted wirelessly, fibre-optically or via other transmission means as would be readily apparent to the skilled person. The sensor unit may comprise (or be in communication with) a signal transmitter (not shown) for this purpose, and the computer system 3 may comprise (or be in communication with) a signal receiver (not shown) for this purpose. In other embodiments, the sensor unit may be omitted and replaced with a database or data memory unit (not shown) remote from the computer system 3. The database or data memory unit may contain measurements previously made by the sensor 2, and may be configured to communicate those measurements (wirelessly or otherwise) to the computer system 3 for processing.

The computer system 3 is configured to implement a method of sampling data from the sensor unit for representing the measurand and the uncertainty in measurements made by the sensor unit in terms of the distribution of measurements within a sample set, via a method comprising the following data processing steps.

A first step is to obtain a data set of measurements generated by the sensor unit, which either comprise a time-sequence of measurements (data elements) or comprise non-sequential group of measurements which are then ordered in time-sequence by the processor.

As a second phase of the data processing comprises the following steps, implemented by the processor unit 4 in conjunction with the buffer memory unit 5:
(a) The processor unit selects a sub-set of the sensor measurements (data elements) from amongst the data set of measurements stored memory unit 6, and places the sub-set into the buffer unit 5. Typically, the sub-set may be selected to include a minimum number of sensor measurements starting with the first sensor measurement (temporally first) within the data set, or the first sensor measurement within the data set that is temporally subsequent to (i.e. not already employed in) an output sample set of measurements within the overall data set. The sensor measurements of the sub-set are temporally consecutive within the data set and, therefore, also within the sub-set. The processor unit then calculates a statistic (such as a moment, of any order) of the distribution of the measurement values of the data elements defining the sub-set. The statistic may comprise a statistical moment of the distribution of the measurements (data elements) in the sub-set, or a function of the statistical moments. Examples include: the first moment (mean), the second moment (variance), third moment (skewness), the fourth moment (kurtosis), or a higher-order moment of the distribution. The processor may then store the value of the statistic in the main memory unit 6 for subsequent recall/use, as follows;
(b) Having calculated and stored the value of the statistic of the distribution of the measurement values, the processor compares the value of the statistic to a reference value stored within the main memory unit 6 and pre-set for the purposes of this comparison step. The reference value may be pre-set to be equal to the value of the statistic calculated in respect of the very first (temporally first) sub-set of measurements generated at step (a) above, or may be set to be equal to the value of the statistic calculated in respect of the immediately previous sample set of measurements output by the computer system. The processor 4 is configured to perform a comparison between the statistic at hand and the reference value. This may comprise calculating the difference, Δ, (e.g. absolute difference) between the statistic and the reference value. A series of conditional steps in the data processing algorithm then proceeds as follows;
(c) As a first conditional step, the processor determines if the value of the statistic calculated for the sub-set at hand differs from the reference value by an amount (Δ) that is less than a threshold amount. If the condition “Δ<Threshold”: is satisfied, then the processor is configured to modifying the sub-set by appending to it at least one additional measurement value (data element) which is subsequent to the sub-set last measurement present in the un-modified sub-set. Then, the processor repeats steps (a) to (c) for the modified sub-set of data elements. In doing so, recursively, the value of the statistic calculated in each modified sub-set, created at each recursion, may change significantly if the appended value of the measurement within the modified sub-set changes significantly due to a significant change in the measurand;
(d) As a second conditional step, if the processor determines that the value of the statistic calculated for the sub-set at hand differs from the reference value by an amount (Δ) that is not less than the threshold amount, then the condition “Δ≥Threshold”: is satisfied. The processor responds this condition by outputting the sub-set collectively as a sample set of measurements (data elements) generated by the sensor unit 2 for representing the measurand and the uncertainty in measurements made by the sensor unit. The processor unit is configured to subsequently repeat steps (a) to (d) in respect of a subsequent sub-set of data elements consecutive within the data set.

In this way, the computer system 3 adaptively determines the time intervals, within the time spanned by the data set of sensor measurements, from which to generate the sample sets for output. The computer system also adaptively determines how many samples are contained in each one of those sample sets.

Smaller sample sets will be more frequent when the measurand is changing significantly, and larger sample sets will be less frequent when the measurand is not changing significantly. This means that the computer system adaptively changes the time-resolution of the sampling of the measurand when generating the output sample sets. The sample sets better represent the measurand and the measurement uncertainty of the sensor unit 2 as a result.

The calculated statistic (e.g. a moment) of a sub-set of measurements may often change as new samples are added to generate the modified sub-set. The processor unit may enforce a minimum number (i.e. not less than a pre-set minimum number/plurality) of samples in a sub-set of measurements when initialisation of the sub-set, and may use the calculated value of their statistic as the reference value. Extra samples may then be added to the initialised sub-set, i.e. each time a modified sub-set(s) is subsequently generated, may then continue until the condition “Δ≥Threshold” is satisfied and the processor puts a halt to that further modification of the sub-set. Alternatively, the processor may set the reference value to be equal to the value of the statistic associated with a previously output sample set of measurements (i.e. output at step (d)). For example, the previously output sample set may be the sample set output immediately prior to the processor unit generating a new sub-set of samples when repeating steps (a) to (d) on the next sub-set of data elements consecutive within the overall data set.

The maximum size of a modified sub-set generated at step (c) is controlled by the processor unit so that it does not exceed a pre-set maximum number of data elements. The value of the pre-set maximum is selected, depending on the circumstances and on a case-by-case basis, to permit that a newly-added measurement in a modified sub-set (at step (c) above) is likely to cause a significant change in the value of the statistic calculated for the modified sub-set when the newly-added measurement is significantly different to the existing measurements in the sub-set. The existence of this significantly different added measurement may signify the onset of a significant change in the measurand. If the size of the modified sub-set is too large, then the newly-added measurement alone may not cause a change in Δ sufficient to satisfy the condition “Δ≥Threshold”.

Accordingly, the processor unit is configured such that if the condition “Δ<Threshold” is satisfied, and the size of the sub-set is greater than the pre-set maximum number of data elements, then the computer system outputs the sub-set of measurements collectively as the sample set of measurements generated by the sensor unit for representing the measurand and for representing uncertainty in measurements made by the sensor unit. The processor unit is configured to subsequently repeat steps (a) to (d) in respect of a subsequent sub-set of consecutive measurements within the data set. As a result of this, if the measurand remains substantially unchanging over a longer time period, the processor provides a way of avoiding an undesirable fall in the sensitivity of the computer system in detecting significant changes in the measurand.

The processor unit may modify a sub-set by appending to the sub-set an additional measurement (data element) which immediately follows on from the final measurement (data element) of the pre-modified sub-set. This increases the number of measurement data elements in the post-modified sub-set to include all of the data elements of the pre-modified sub-set as well as the appended measurement data element. Alternatively, the processor unit may modify a sub-set to have the effect that the time points demarcating the beginning and end of the sub-set, in time, move forward in time in unison in the manner of a ‘sliding window’. The processor may be configured to perform this by maintaining a constant number of data elements in the sub-set during the ‘modification’ process whereby the processor excludes/removes the temporally ‘first’ measurement data element of the pre-modified sub-set and appends the additional measurement data element to the sub-set. This maintains a fixed size for the sub-set by removing the ‘earliest’ (temporally speaking) measurement data element to make room for the ‘latest’ (i.e. the appended) data element.

The computer system 3 is configured to output each sample set by one or more of: storing the sample set in an external memory 7; storing the statistic in the external memory 7; transmitting a signal 9 comprising the sample set via the transmitter unit 8; transmitting a signal 9 comprising a calculated representation of the distribution of via the transmitter unit 8. In addition, the computer system 3 may store the sample set in local memory 6. The external memory 7 may be a remote memory of a remote computer system, or memory unit.

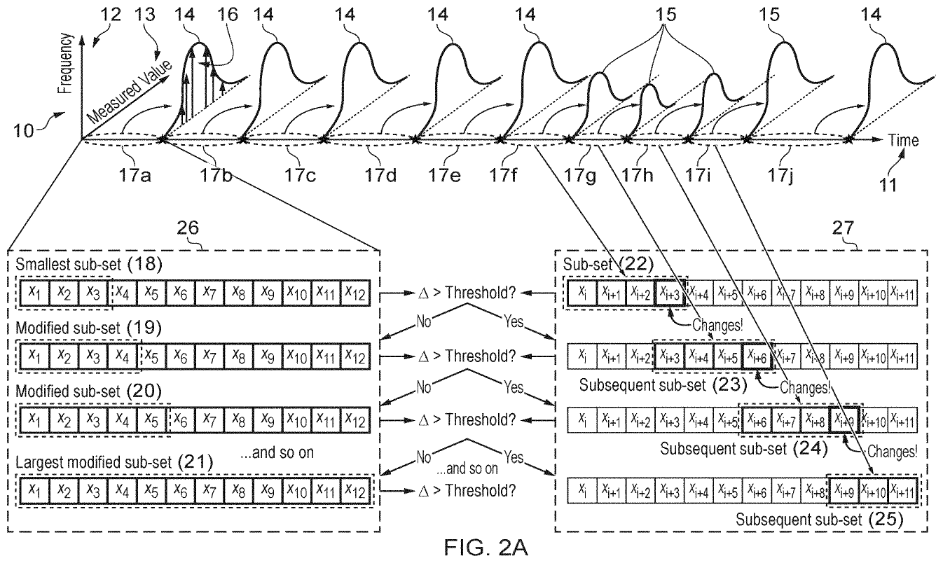

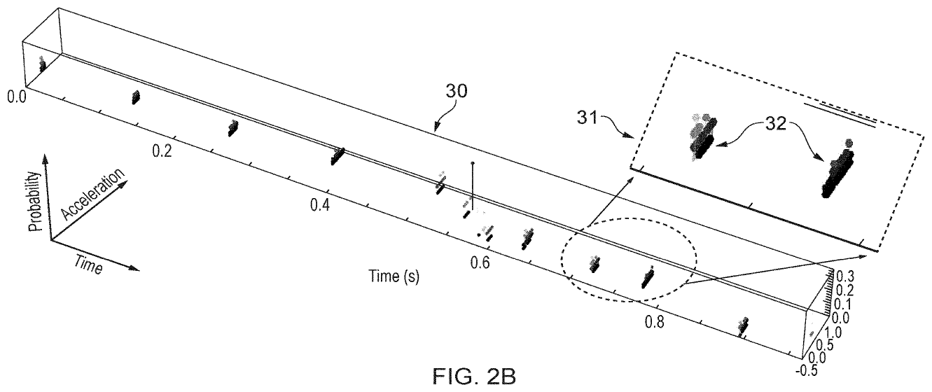

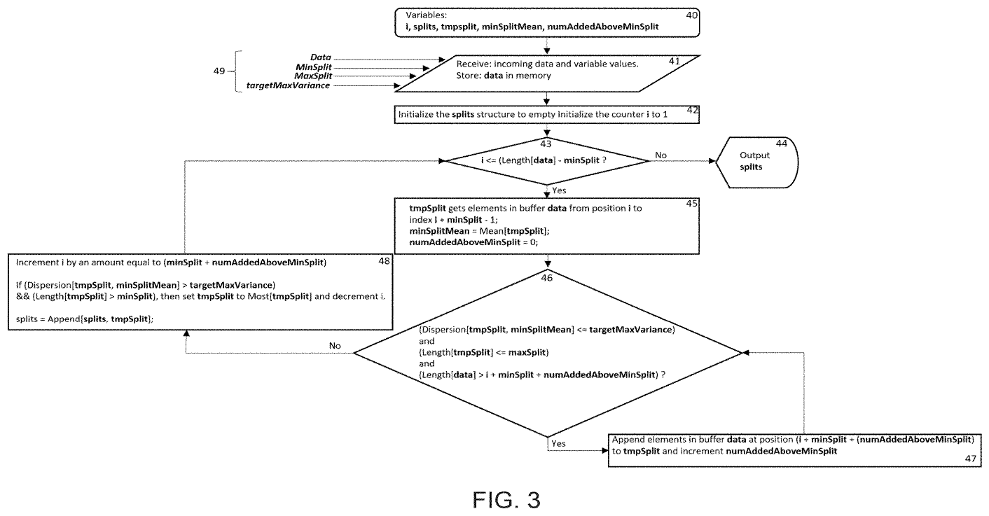

FIG. 2A schematically shows the implementation of the data processing algorithm of the processor unit 4 as applied to a time-sequence of measurement data items 11 generated by the sensor unit 2. The time-sequence is shown as one linear dimension in a three-dimensional graphical coordinate system 10 having the following three orthogonal axes. The axis along the page is the ‘time’ axis along which the times of measurement of each of the measurement data elements of the data set is arranged in sequence thereby to form a time-sequence arrangement of measurement times along that axis. Along this time axis is shown a plurality of separate sequential data sub-sets (17a, 17b, 17c, 17d, 17e, 17f, 17g, 17h, 17i, 17j). Within each subset is a plurality of time-sequential measurement data items demarcated by a respective start time and a respective end time (symbol: ⋆). The end time of a preceding sub-set is followed by the start time of the succeeding sub-set which begins with the immediately subsequent measurement data item in the overall time-sequence of the data set.

The axis 13 directed into the page denotes scale on which the range of measurement values covered by all of the measurements in a given sub-set is arranged. This range is divided into successive measurement sub-ranges, or ‘bins’, preferably of equal size, in ascending order. This defines the ordinate axis of a frequency histogram, or probability distribution for measurements by the sensor unit (when individual frequency values are divided/normalised by the total number of elements in that data sub-set), of the values of the measurements in the sub-set.

The vertically directed axis 12 denotes the frequency (or probability), in a histogram form, for each of the measurement value sub-ranges, or ‘bins’, across the range of measurement values covered by all of the measurements in a given sub-set. For example, if measurement values tend to fall within a given sub-range, or ‘bin’, frequently, then this is reflected in the height 16 of the ‘frequency’ distribution (or probability distribution) of the measured values within that sub-set. For illustrative purposes, the heights of the frequency (probability) distribution in respect of six separate measurement sub-ranges, or ‘bins’, associated with the first data sub-set 17a of the overall data set. A continuous envelope curve 14 is also shown for this frequency (probability) distribution to indicate the underlying distribution shape for that sub-set of data 17a. Similarly, temporally successive sub-groups of (17b, 17c, 17d, 17e, 17f, 17g, 17h, 17i, 17j) each also define a respective frequency histogram, or probability distribution for measurements by the sensor unit and this is indicated by the continuous envelope curve (14 or 15) for the frequency (probability) distribution of the sub-set in question to indicate the underlying distribution shape for that sub-set of data: the individual heights 16 of frequency/probability values within the individual sub-ranges, or ‘bins’, of the successive sub-sets are not shown, purely to aid clarity. In this way, clusters of data forming individual data distributions (14, 15) correspond to the measurements taken in the sub-interval of time between the time position at which they are collected on the time axis and the time position at which the next cluster of data are collected on the time axis.

In more detail, consider the first sub-set of measurements 17a, in the time-series. The processing of this sub-set of measurement data, by the computer system 3, proceeds as schematically shown in box 26 of FIG. 2A. The first sub-set 18 initially comprises three measurement data items x₁, x₂ and x₃. This is the smallest size of sub-set that the computer system will allow. The computer system places these three data items in the buffer memory unit 5. The processor unit 4 then reads the values of the three data items in the buffer memory unit and calculates a ‘moment’ of their distribution 14: this is the ‘statistic’ referred to above. As an example, the ‘moment’ may be the average value (first moment) of the three measurement data items. In other examples, a higher ‘moment’ may be calculated for use as the ‘statistic’, if that is more suitable. This will be at the discretion and judgement of the user.

The processor then calculates the difference, A, (e.g. absolute value) between the value of the statistic and the value of a pre-set threshold. This pre-set threshold is a value of the statistic as calculated in respect of an immediately preceding (temporally) sample set of measurements data items (not shown) occurring before the sub-set 17a at hand. Next, the processor determines if the condition: “Δ>Threshold” is met. If it is not, then the computer system appends a subsequent measurement data item x₄, to the sub-set 18 of data items within the buffer memory unit 5. The result is a modified sub-set 19 of data items: x₁, x₂, x₃ and x₄. The processor unit 4 then reads the values of the four data items in the buffer memory unit and calculates the ‘moment’ of their distribution 14 (the same moment type as selected for the sub-set 18). The processor then calculates the difference, A, (e.g. absolute value) between the value of the statistic and the value of the pre-set threshold. Next, the processor determines if the condition: “Δ>Threshold” is met. If it is not, then the computer system appends a subsequent measurement data item x₅, to the modified sub-set 19 of data items within the buffer memory unit 5. The result is a modified sub-set 20 of data items: x₁, x₂, x₃, x₄, and x₅. The processor unit 4 then reads the values of the five data items in the buffer memory unit and calculates the ‘moment’ of their distribution 14 (the same moment type as selected for the sub-set 19). The processor then calculates the difference, Δ, (e.g. absolute value) between the value of the statistic and the value of the pre-set threshold. Next, the processor determines if the condition: “Δ>Threshold” is met. If it is not, then the computer system appends a subsequent measurement data item x₆, to the modified sub-set 20 of data items within the buffer memory unit 5.

The process of modifying the sub-set and checking the condition: “Δ>Threshold” continues until either the condition is met, or until the number of data elements in the modified sub-set: x₁, x₂, x₃, x₄, . . . xₙ reaches the is the largest size of sub-set that the computer system will allow. An example of this is sub-set 21 containing twelve measurement data items: x₁, x₂, x₃, x₄, . . . x₁₂. The processor unit 4 reads the values of the twelve data items in the buffer memory unit 5 and calculates the ‘moment’ of their distribution 14 (the same moment type as selected for the sub-set 20). The processor then calculates the difference, Δ, (e.g. absolute value) between the value of the statistic and the value of the pre-set threshold. Next, the processor determines if the condition: “Δ>Threshold” is met. In this example, the condition is not met and so the computer system 3 outputs these twelve measurement data items as one sample data set for accurately representing the value of the measurand and the uncertainty in measurements made by the sensor unit 2. This set of circumstances is shown as occurring successively for largest sub-sets 17a, 17b, 17c, 17d, and 17e in FIG. 2A. In those instances, the computer system 3 also outputs the twelve measurement data items of each one of these largest sub-sets 17a, 17b, 17c, 17d, and 17e respectively as one sample date set for accurately representing the value of the measurand and the uncertainty in measurements made by the sensor unit 2.

In contrast to this circumstance, if the processor does positively determine that the condition: “Δ>Threshold” is indeed met, then the processor proceeds in the manner illustrated in box 27 of FIG. 2.

Here, after having determined that the condition: “Δ>Threshold” is not met in respect of a smallest sub-set of three measurement data items (xᵢ, xᵢ₊₁, xᵢ₊₂), a modified sub-set 22 of four measurement data points (xᵢ, xᵢ₊₁, xᵢ₊₂, xᵢ₊₃) generated by appending a fourth measurement data item (xᵢ₊₃) to the sub-set in the memory buffer unit 5. The processor unit 4 then reads the values of the four data items in the buffer memory unit and calculates the ‘moment’ of their distribution 15 (the same moment type as selected for the sub-set 21). The processor then calculates the difference, Δ, (e.g. absolute value) between the value of the statistic and the value of the pre-set threshold. Next, the processor determines if the condition: “Δ>Threshold” is met and finds that it is met. The computer system then outputs the un-modified sub-set of three measurement data items (xᵢ, xᵢ₊₁, xᵢ₊₂) as a sample set 17f for accurately representing the value of the measurand and the uncertainty in measurements made by the sensor unit 2. Note that the fourth measurement data item (xᵢ₊₃) is deliberately omitted from the sample set output by the computer system. This is because the value of the fourth measurement data item (xᵢ₊₃) was sufficiently different from other three measurement data items in the (xᵢ, xᵢ₊₁, xᵢ₊₂) that it caused a significant change (see “changes!” box 27) in the ‘statistic’ for the sub-set containing it. This indicates that there was a significant change in the measurand at the time point when the fourth measurement data item was generated/measured.

Next, the computer system repeats this process for the subsequent sub-set 23 which now includes the fourth measurement data item (xᵢ₊₃) omitted from the previous sample set 17f. This inclusion to allow the computer system to determine if/when the measurand changes again, subsequently to the time of the fourth measurement data item (xᵢ₊₃). It is found, in this example, that another significant change in the measurand occurs at the time when measurement xᵢ₊₆ was made. As a result, the computer system then outputs the sub-set of three measurement data items (xᵢ₊₃, xᵢ₊₄, xᵢ₊₅) as a sample set 17g for accurately representing the value of the measurand and the uncertainty in measurements made by the sensor unit 2. Note that the seventh measurement data item (xᵢ₊₆) is deliberately omitted from the sample set output by the computer system.

Subsequently, the computer system again repeats this process for the subsequent sub-set 24 which now includes the seventh measurement data item (xᵢ₊₆) omitted from the previous sample set 17g. This inclusion to allow the computer system to determine if/when the measurand changes again, subsequently to the time of the seventh measurement data item (xᵢ₊₆). It is found, in this example, that another significant change in the measurand occurs at the time when measurement xᵢ₊₉ was made. As a result, the computer system then outputs the sub-set of three measurement data items (xᵢ₊₆, xᵢ₊₇, xᵢ₊₈) as a sample set 17h for accurately representing the value of the measurand and the uncertainty in measurements made by the sensor unit 2. Note that the tenth measurement data item (xᵢ₊₉) is deliberately omitted from the sample set output by the computer system.

The processor continues in the manner exemplified in boxes 26 or 27, as described above, depending on when/if the condition: “Δ>Threshold” is met, until the whole data set of measurements is processed. As an example, FIG. 2B shows a series of distributions of acceleration measurements output by an accelerometer, taken over a 1-second time interval. The axis directed into the page denotes acceleration measurement value, the axis directed from left to right of the figure denotes time, and the vertically directed axis is the associated with the probability (e.g. frequency, in a histogram) for each measurement value in a distribution of the measured values obtained during a sub-interval of time. The clusters of points are the measurements taken in the sub-interval of time between the time position at which they are collected on the time axis and the position at which the next cluster of points are collected on the time axis. The wider is their spread, along the acceleration measurement axis, the more uncertain is the measurement during sub-interval of time. The computer system has adaptively determined the time between the sample sets (i.e. batches of samples) as can be seen by e.g. the separate sample sets (distributions) at and around a time of 0.6s being closer together in time while those at earlier and later times are further apart in time. FIG. 2B shows the time series of measurements, first with the measurements grouped into fixed sized sample sets (batches) over time as well as with the measurements grouped into adaptive sample sets (batches). The figure shows how the adaptive method reduces the number of samples in each sample set (batch) when the measurand is changing and thereby permits more accurate depiction of the time-varying measurand in the last parts of the sequence of measurements.

### EXAMPLES

### Example 1

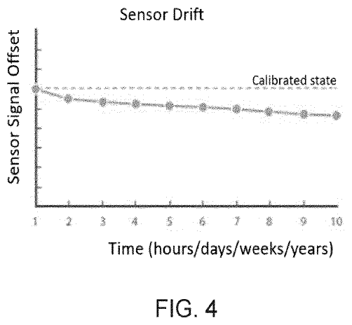

The flowchart 1 of FIG. 4 shows the steps in an example implementation of the method. The method is applied to a buffer of samples contained in the buffer memory unit 5 which, in one implementation, is implemented using an array of memory structures such as a multi-bit D-type flip flop or register, in hardware.

Each of the operations: Dispersion[ ], Append[ ], Length[ ], and Mean[ ], represent digital logic circuits for performing operations on the elements in the buffer.

### BLOCK 40:

The variables: i; splits; tmpsplit; minSplitMean; numAddedAboveMinSplit; represent respectively: the counter to denote a position, in the sequence of data, of a measurement data item; a sample set of measurement data items for output; a sub-set of measurement data items; the mean value of the sub-set of measurement data items having the minimum allowed sub-set size; the increment in the size of a sub-set when it is modified by appending another measurement data item.

### BLOCK 41:

The process includes receiving (49) incoming Data comprising the set of measurement data items to be processes, as well as input variable values: targetMaxVariance; MaxSpit; MinSplit which represent, respectively: the ‘Thresold’ value noted above; the maximum allowable sub-set size noted above; the minimum allowable sub-set size noted above. The Data is stored in main memory unit 6.

### BLOCK 42:

The generation of a sub-set is initialised first setting the value of the counter i to 1.

### BLOCK 43:

Then the query follows: i<=(Length[data]−minSplit?
BLOCK 44: If the answer is ‘No’, then the command to ‘Output splits’ follows. This outputs the sub-set at hand as a sample set.
BLOCK 45: If the answer is ‘Yes’, then the command tmpSplit gets the data elements in the buffer memory from position i to index i+minSplit−1;

The following commands are then executed:

$$minSplitMean = Mean [ tmpSlit ] ;$$

$$numAddedAboveMinSplit = 0 ;$$

### BLOCK 46:

Next, the operations Dispersion[ . . . ], Length[ . . . ] and Mean[ . . . ] are executed and the following query is performed:

$$( Dispersion [ tmpSplit , minSplitMean ] <= targetMaxVariance )$$

$$and$$

$$( Length [ tmpSplit ] <= maxSplit )$$

$$and$$

$$( Length [ data ] > i + minSplit + numAddedAboveMinSplit ) ?$$

BLOCK 48: If the answer is ‘No’, then the command is executed to increment i by an amount equal to (minSplit+numAddedAboveMinSplit) and to set tmpSplit to Most[tmpSplit] and to decrement the value of counter i if:
(Dispersion[tmpSplit, minSplitMean]>targetMaxVariance) && (Length[tmpSplit]>minSplit),
The variable is set to: splits=Append[splits, tmpSplit];
Next, the process returns to BLOCK 43.
BLOCK 47: If the answer is ‘Yes’, then the command to append elements in buffer memory at position (i+minSplit+(numAddedAboveMinSplit) to tmpSplit is executed and to increment the value of numAddedAboveMinSplit
Next, the process returns to BLOCK 46.

### EXAMPLES

Referring once more to FIG. 1, in an alternative aspect of the invention, or in addition to aspects disclosed herein, an apparatus 1 is shown according to an embodiment of the invention. The measurement apparatus comprises a measurements device 2 in the form of a sensor unit (e.g. a LiDAR sensor, an accelerometer, etc.) configured to generate measurements of a pre-determined measurable quantity: a measurand (e.g. distance, acceleration etc.). The measurement apparatus further includes a computer system 3 including a processor 4 in communication with a local buffer memory unit 5 and a local main memory unit 6. The computer system is configured to receive, as input, data from the sensor unit representing measurements of the measurand (i.e. distance, acceleration etc.), and to store the received measurements in the local main memory unit 6. The processor unit 4, in conjunction with the buffer memory unit 5, is configured to apply to the stored measurements a data processing algorithm configured for sampling the measurements from a sensor stored in main memory, so as to generate a value/estimate of the probability that a measurement value (x) is the result of a given value of the measurand (θ). The sample sets of measurements each represent, or convey, the uncertainty in measurements made by the sensor unit 2. The value/estimate of the probability permits the user to determine how accurately the sensor is sensing the measurand.

This value/estimate of the probability is obtained by adaptively generating an estimate for the Prior distribution for the measurand based on an aggregation of measurement values over time.

The computer system is configured to output the value/estimate of the probability, once generated, either to its main memory 6 for further use, and/or to transmit the value/estimate of the probability to an external memory 7 arranged in communication with the computer system for further use, and/or to transmit via a transmitter unit 8 one or more signals 9 conveying the value/estimate of the probability to a remote receiver (not shown). The signal may be transmitted wirelessly, fibre-optically or via other transmission means as would be readily apparent to the skilled person.

In other embodiments, the sensor unit is remote from the computer system 3, and is configured to remotely transmit measurements (wirelessly or otherwise) to the computer system 3 which, in turn, is configured to wirelessly receive, as input, data from the sensor unit transmitted wirelessly, fibre-optically or via other transmission means as would be readily apparent to the skilled person. The sensor unit may comprise (or be in communication with) a signal transmitter (not shown) for this purpose, and the computer system 3 may comprise (or be in communication with) a signal receiver (not shown) for this purpose. In other embodiments, the sensor unit may be omitted and replaced with a database or data memory unit (not shown) remote from the computer system 3. The database or data memory unit may contain measurements previously made by the sensor 2, and may be configured to communicate those measurements (wirelessly or otherwise) to the computer system 3 for processing.

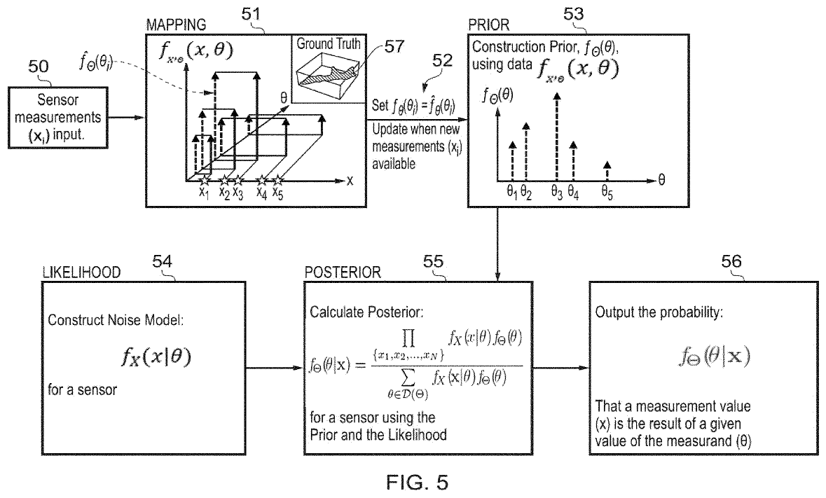

The computer system 3 is configured to implement a method of sampling the measurements from the sensor so as to generate a value/estimate of the probability that a measurement value (x) is the result of a given value of the measurand (θ), via a method comprising the following data processing steps which are schematically illustrated in FIG. 5.

A first step 50 is to receive a plurality of measurement values (xᵢ) made by the sensor unit. Next, the computer processor 4 is configured to perform a mapping process 51 to map the plurality of measurement values (x=(x₁, x₂, x₃, x₄, x₅)^{T}) to a corresponding plurality of individual measurand values (x₁→θ₁; x₂→θ₂; x₃→θ₃; x₄→θ₄; x₅→θ₅). A pre-existing mapping table (a lookup table) is stored in the memory unit 6. The processor implements a mapping (ƒₓ,Θ(x,θ)) using the mapping table. In particular, the computer system 3 defines each one of the plurality of tabulated measurement value ‘bins’ by a sub-range comprising upper and lower values: \hat{x}_{Ui}, \hat{x}_{Li}, between which a given measurement value may fall such that: \hat{x}_{Li}<xᵢ<\hat{x}_{Ui}. Table 1 shows an example:

TABLE 1

| | | | | Distribution (F(x)) of prior |
|---|---|---|---|---|
| Bin Number | Measurement Bin | Mapping | Measurand Bin | measurements |
| 1 | \hat{x}_{L1} < x₁ < \hat{x}_{U1} | → | \hat{θ}_{L1} < θ₁ < \hat{θ}_{U1} | F(Bin#1) |
| 2 | \hat{x}_{L2} < x₂ < \hat{x}_{U2} | → | \hat{θ}_{L2} < θ₂ < \hat{θ}_{U2} | F(Bin#2) |
| 4 | \hat{x}_{L3} < x₃ < \hat{x}_{U3} | → | \hat{θ}_{L3} < θ₃ < \hat{θ}_{U3} | F(Bin#3) |
| 4 | \hat{x}_{L4} < x₄ < \hat{x}_{U4} | → | \hat{θ}_{L4} < θ₄ < \hat{θ}_{U4} | F(Bin#4) |
| 5 | \hat{x}_{L5} < x₅ < \hat{x}_{U5} | → | \hat{θ}_{L5} < θ₅ < \hat{θ}_{U5} | F(Bin#5) |
| . . . etc. . . . | . . . etc. . . . | → | . . . etc. . . . | . . . etc. . . . |
| i | \hat{x}_{Li} < xᵢ < \hat{x}_{Ui} | → | \hat{θ}_{Li} < θᵢ < \hat{θ}_{Ui} | F(Bin#i) |
| . . . etc. . . . | . . . etc. . . . | → | . . . etc. . . . | . . . etc. . . . |

The computer system performs the mapping by searching the mapping table to identify the tabulated measurement value ‘bin’ number within which a given measurement value, xᵢ, at hand falls such that: \hat{x}_{Li}<xᵢ<\hat{x}_{Ui}, and then maps the identified measurement bin to a corresponding measurand bin for which \hat{θ}_{Li}<θᵢ<\hat{θ}_{Ui}, as follows:

$$\hat{x} \approx {x}_{i} \to {θ}_{i} \approx \hat{θ} .$$

The mapping table also comprises a plurality of tabulated values for a distribution F(x) of prior (i.e. previous/earlier) measurement values as made by a reference sensor, the values occurring within the ‘bins’ of the mapping table and thereby forming a reference frequency or probability distribution of binned sensor measurement.

The reference measurement apparatus may be another instance of (i.e. of the same construction, structure and properties, e.g. substantially identical) the measurement apparatus by which the measurements at hand are generated. This reference measurement apparatus may be a ‘trusted source’ of a “ground truth” set of measurement values. Alternatively, and in the present example, the reference measurement apparatus is the self-same measurement apparatus by which the measurements at hand are generated. The computer system 3 is configured to continuously store in the main memory unit 6 each of the successive measurement values (xᵢ) contemporaneously generated by the sensor unit 2 thereby to update and extend the contents of the memory unit with each new measurement value generated by the sensor. The computer system 3 generates the distribution, F(x), of the aggregation of these prior measurement values (xᵢ) stored in the memory. The computer may update the distribution, F(x), of prior measurements in response to an update (i.e. a new measurement value) extending the contents of the memory unit 6. The mapping: \hat{x}→θ described above is performed, by the computer, based on the distribution, F(x), of the prior measurements such that each tabulated measurement value (\hat{x}) in the mapping table maps to a corresponding value (e.g. the same measurement value) of the distribution (F(x=\hat{x})) of the prior measurements, with the result that an estimated value, \hat{ƒ}_{Θ}(θᵢ), of the Prior distribution (ƒ_{Θ}(θ)) for the measurand is obtained from the relation:

$${\hat{f}}_{Θ} ( {θ}_{i} ) = F ( \hat{x} )$$

In preferred embodiments, the computer system 3 applies an averaging process, or smoothing process, to the distribution (F(x)) of the prior measurements to reduce noise levels within the distribution. This distribution is used, by the computer system, as a reference Prior function (\hat{ƒ}_{Θ}(θ)) for generating a Prior distribution, ƒ_{Θ}(θ)=\hat{ƒ}_{Θ}(θᵢ), for the measurand (θ). This also allows the reference measurement apparatus to provide a “ground truth” set of measurement values and a distribution for them (F(x)), from which to generate a Prior distribution, ƒ_{Θ}(θ) for the measurand. In particular, referring to FIG. 5, the joint distribution ƒ_{x,Θ}(x,θ) is schematically shown in process box 51 and this provides a “ground truth”. The insert box within process box 51, illustrates an actual joint distribution 57 for a real reference sensor as opposed to the schematic joint distribution shown in box 51. The schematic joint distribution is used in FIG. 5 for better clarity.

In preferred embodiments, the computer may estimate an analytical form for the distribution, F(x), of the aggregation of prior measurement values (xᵢ) stored in the memory. The estimated analytical form for the distribution (F(x)) may be used, by the computer, as the reference Prior function (\hat{ƒ}Θ(θ)).

In particular, referring to FIG. 5, the prior distribution (ƒ_{Θ}(θ)) illustrated in process box 53, shows the value of the Prior distribution ƒ_{Θ}(θᵢ) for the five measurand values: θ₁, θ₂, θ₃, θ₄, θ₅, in terms of the heights of these dashed vertical arrows distributed along the ordinate axis (θ). The heights and positions of these dashed arrows are equal to the heights and positions of the vertical dashed arrows arranged along the axis for the measurand (θ) of the joint distribution ƒ_{x,Θ}(x,θ) schematically shown in process box 51 of FIG. 5. Furthermore, the heights of these dashed arrows are equal to the heights of the solid arrows denoting the value of the distribution (F(x)) of the prior measurements. The mapping process: \hat{x}≈xᵢ→θᵢ≈\hat{θ} is equivalent to projecting the solid vertical arrows onto the axis for the measurand (θ) of the joint distribution ƒ_{x,Θ}(x,θ) schematically shown in process box 51 of FIG. 5. The result is an estimated value, \hat{ƒ}_{Θ}(θᵢ), of the Prior distribution and this used 52 as a Prior distribution, ƒ_{Θ}(θ), for the measurand (θ) at process box 53 of FIG. 5. In this way, the processor 4 unit is configured to generate 53 a Prior distribution (ƒ_{Θ}(θ)) for the measurand (θ) based on the mapping (ƒ_{x,Θ}(x,θ)) of measurement values (x) to measurand values (θ). The joint distribution ƒ_{x,Θ}(x,θ) is used, by this projection, as the reference Prior function (\hat{ƒ}_{Θ}(θ)). The Prior distribution is stored in the main memory unit 6 and is also temporarily stored in the buffer memory unit 5 for the purposes of a subsequent calculation, described below. The Prior distribution is continuously updated 52, as described above, as new measurement values are received by the computer system, from the sensor unit 2.

Subsequently, the processor unit 4 retrieves a pre-prepared Likelihood function (ƒₓ(x|θ)) 54 from the main memory unit 6. This Likelihood is stored in the main memory unit 6 and is also temporarily stored in the buffer memory unit for the purposes of a subsequent calculation, described below. The pre-prepared Likelihood function (ƒₓ(x|θ)) defines a likelihood for the measurement values (x) associated with a given measurand (θ). The computer system provide a Likelihood function (ƒₓ(x|θ)) in the form of a numerical or mathematical model for the measurement ‘noise’ of the measurement apparatus. In some embodiments, this is provided as an analytical/mathematical function. The analytical function may be selected from any suitable ‘named’ probability distribution such as, but not limited to, any of: Gaussian, Poisson, Log-Normal, Binomial, Beta-distribution. Alternatively, a numerical model may comprise a numerical function generated by a computer simulation such as a Monte Carlo statistical simulation, or other statistical or numerical simulation by which the ‘noisy’ response of the measurement apparatus may be modelled.

Next, processor unit 4 calculates 55 a Posterior function (ƒ_{Θ}(θ|x)) for the measurement using the Prior distribution and the Likelihood function, both of which are stored in the buffer memory unit 5, according to a Bayes-Laplace rule. The processor unit calculates a Posterior function (ƒ_{Θ}(θ|X)) for the plurality of measurement values (x=(x₁, x₂, x₃, x₄, x₅)^{T}) using the following Posterior function:

$${f}_{Θ} ( θ \vert x ) = \frac{{\prod }_{\{ {x}_{1} , {x}_{2} , … , {x}_{N} \}} {f}_{X} ( x \vert θ ) {f}_{Θ} ( θ )}{{\sum }_{θ ∈ 𝒟 ( Θ )} {f}_{X} ( x \vert θ ) {f}_{Θ} ( θ )}$$

The quantity (x) in the Posterior function ƒ_{Θ}(θ|x) is a vector of N separate measurement values, (xᵢ), each of which is itself one separate scalar measurement value (i.e. the vector of N measurements: x=(x₁, x₂, . . . , x_{N})^{T}). The processor unit 4 then outputs 56 the value of the Posterior function to the main memory unit for storing there, and the computer system 3 outputs the value of the Posterior function as a probability that a measurement value (x), or values (x), made by the sensor unit 2 is the result of a given value of the measurand (θ) measured by the sensor.

The computer system is configured to update the plurality of measurement values stored in the mapping table as and when a new measurement value is generated by the measurement apparatus. The computer system is thereby able to update the mapping process described above using the updated plurality of measurement values, and therewith calculate an updated Prior function. Consequently, the computer system calculates, and outputs, an updated value for the Posterior function based on the updated Prior function. This allows the invention to adaptively update the value of the probability that a measurement value (x), or group of measurement values (x), is the result of a given value of the measurand (θ). This updating may be done, by the computer system, continuously over a period of time in response to each new measurement value being received thereby, or periodically at selected time intervals.

In alternative embodiments, the tabulated measurement values of the mapping table do not comprise measurement value sub-ranges, or ‘bins’, but instead comprise the stored values, e.g. arrayed in ascending order, of prior measurements (x) and the corresponding value of the distribution (F(x)) of the prior measurements associated with that measurement value. Table 2 shows an example. The distribution (F(x)) of the prior measurements may be represented, by the computer system, as an analytical/mathematical or numerical function.

TABLE 2

| Measurement | | Measurand | Distribution (F(x)) of prior |
|---|---|---|---|
| Stored | Mapping | Stored | measurements |
| \hat{x}₁ | → | \hat{θ}₁ | F(\hat{x}₁) |
| \hat{x}₂ | → | \hat{θ}₂ | F(\hat{x}₂) |
| \hat{x}₃ | → | \hat{θ}₃ | F(\hat{x}₃) |
| \hat{x}₄ | → | \hat{θ}₄ | F(\hat{x}₄) |
| \hat{x}₅ | → | \hat{θ}₅ | F(\hat{x}₅) |
| . . . etc. . . . | → | . . . etc. . . . | . . . etc. . . . |
| \hat{x}ᵢ | → | \hat{θ}ᵢ | F(\hat{x}ᵢ) |
| . . . etc. . . . | → | . . . etc. . . . | . . . etc. . . . |

In that case the computer may be configured to search the mapping table to identify the tabulated measurement value closest (in value) to the a given measurement value, xᵢ, at hand (i.e. find \hat{x}≈xᵢ) and then map the given measurement value, xᵢ, to a measurand value (θ), as follows: \hat{x}≈xᵢ→θᵢ. The computer may identify the two closest tabulated measurement values (i.e. upper and lower values: \hat{x}_{U}, \hat{x}_{L}), between which the given measurement value falls, that are closest in value to the given measurement value, xᵢ, such that: \hat{x}_{L}<xᵢ<\hat{x}_{U}, and map each of the two closest tabulated measurement values to a respective measurand value (i.e. upper and lower values: \hat{x}U→θ_{U}, \hat{x}_{L}→θ_{L}) The computer system may then interpolate between the two respective measurand values and calculate an interpolated measurand value (θᵢ) mapped to the given measurement value, xᵢ. A linear interpolation may be employed whereby:

$${x}_{i} \to {\tilde{θ}}_{i} = \frac{{θ}_{U} - {θ}_{L}}{{\hat{x}}_{U} - {\hat{x}}_{L}} ( {x}_{i} - {\hat{x}}_{L} ) + {θ}_{L}$$

The mapping table (Table 2) comprises a plurality of tabulated values for the distribution (frequency or probability distribution) distribution (F(\hat{x})) of prior measurements of the tabulated measurement values (\hat{x}). This distribution is used as a reference Prior function (\hat{ƒ}_{Θ}(θ)) for generating a Prior distribution, ƒ_{Θ}(θ), for the measurand (θ): ƒ_{Θ}(θ)=ƒ_{Θ}(θᵢ)=F(\hat{x}). This provides a “ground truth” set of measurement values and a distribution for them, from which to generate a Prior distribution, ƒ_{Θ}(θ). With the interpolation of measurement values occurs, as described above, the computer system interpolates corresponding values of the reference Prior function (\hat{ƒ}_{Θ}(θ)) for the measurand (θ) e.g. by linear interpolation whereby:

$${\hat{f}}_{Θ} ( {\tilde{θ}}_{i} ) = \frac{{\hat{f}}_{Θ} ( {θ}_{U} ) - {\hat{f}}_{Θ} ( {θ}_{L} )}{{θ}_{U} - {θ}_{L}} ( {\tilde{θ}}_{i} - {θ}_{L} ) + {\hat{f}}_{Θ} ( {θ}_{L} )$$

### Example 1

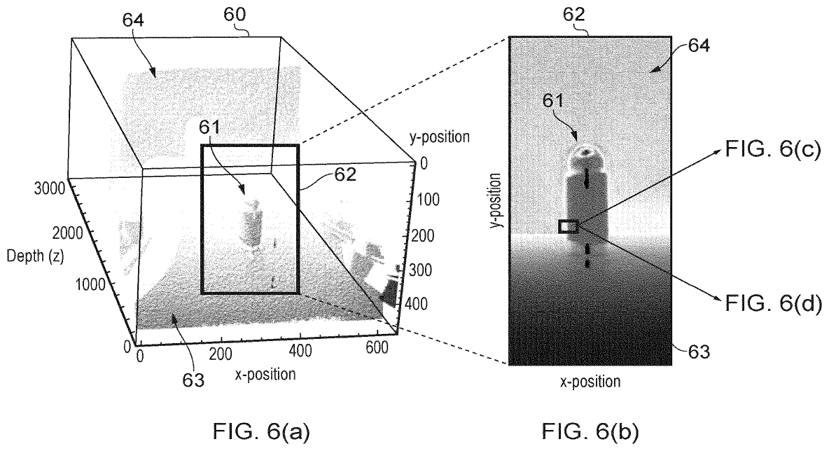

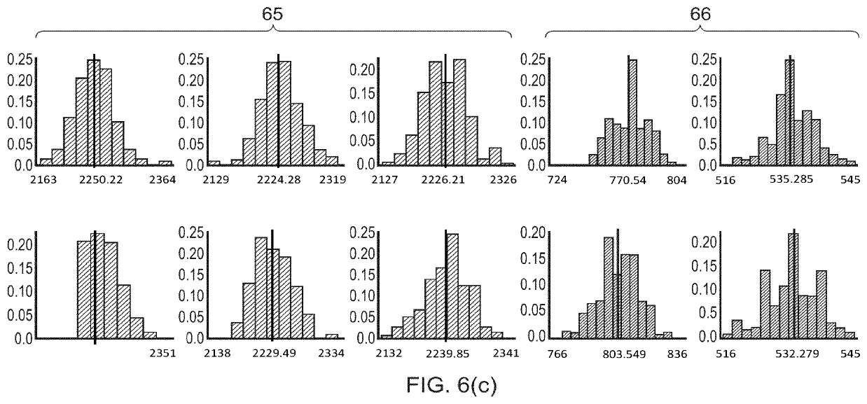

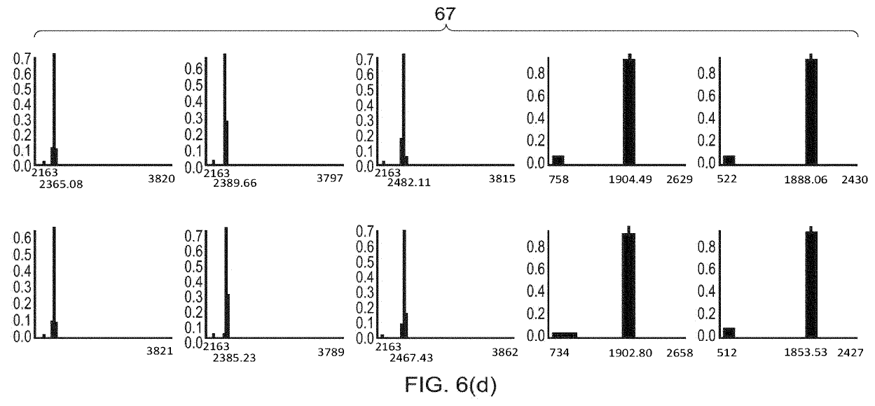

FIG. 6 shows LiDAR depth images and the distributions of depth measurements made by the LiDAR depth measurement sensor (not shown).

Part (a) of FIG. 6 shows a LiDAR depth image 60 in three orthogonal spatial dimensions (3D: ‘Depth’, or z-dimension; x-Position; y-Position) in respect of an object 61 (a bottle) located on a flat surface 63 (a table-top) in front of a flat surface 64 (a wall). Part (b) of FIG. 6 shows an excerpt 62 of the LiDAR depth image 60 of Part (a) in a 2D view showing the x-Position and the y-Position, and indicating ‘Depth’ via the colour/greyscale value of the image.

Parts (c) and (d) of FIG. 6 show examples of the distribution a large number of distance measurements for a selected ten positions (x, y) in the 2D plane of the image of Part (b) of FIG. 6. Part (c) shows the distributions of the many measurement values in respect of ten neighbouring pixels spanning a vertical edge of the bottle (i.e. by “vertical” we mean: y-Position is constant in value; x-Position varies in value). In parts [c] and [d], there are distributions for two y-positions shown (and five x-positions). Here the LiDAR sensor is set to a low depth resolution. A first group 65 of six of these pixels correspond to a x-Positions in which the flat surface (wall 64) is visible, whereas second group 66 of four of these pixels correspond to a x-Positions in which a curved cylindrical surface (bottle 61) of the foreground object begins to obscure the background surface. The uncertainty of the depth measurements at and close to this curved cylindrical surface, where depth changes rapidly over a small change in x-Position, is clear from the large spread in the distribution of measurement values. Notably, often the distributions are Gaussian.

Part (d) shows the distributions of the same number of many measurement values (i.e. per Part (c)) in respect of eight neighbouring pixels spanning the same surface of the bottle, but in which the LiDAR sensor is set to a higher resolution than that in Part (c). It can be seen that the uncertainty in the LiDAR depth measurement values is far less than in the lower resolution mode—the distributions have much lower variance—however, the distributions often have significant outliers.

This shows that the depth measurement uncertainty for two different distance-resolution modes of operation of the LiDAR sensor are very different, and also that the depth measurement uncertainty varies across pixels when used in any given LiDAR resolution mode. The invention provides a means of using these distributions of measurements values, for each pixel, to quantify probability that a measurement value (x), or values (x), made by the LiDAR sensor at a given x-Position and y-Position, is the result of a given true value of the depth (measurand (θ)) measured by the LiDAR sensor. This permits the user, or an automated system, to assign confidence values to depth measurements across the LiDAR image (e.g. images of Part (a) or Part (b)), and/or to quantify uncertainty or risk when making decisions based on those measurement values.

### Example 2

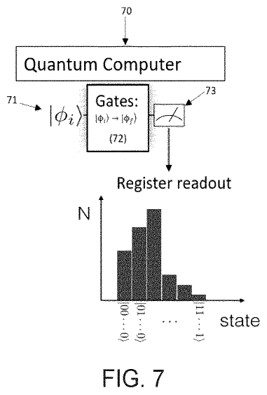

FIG. 7 shows a schematic representation of a quantum computer. The quantum computer 70 comprises a quantum register 71 within which qubits are stored in such a way as to define a quantum state, Iϕᵢ [symbol] , of the register. The quantum computer also comprises a circuit of quantum logic gates 72 configured in such a way as to implement a desired sequence of gate operations (e.g. CNOT, Hadamard, entanglement etc.) on the initial quantum state, |ϕᵢ [symbol] , of the quantum register (i.e. a program) resulting in the qubits within the register storing a final quantum state, |ϕ_{ƒ} [symbol] , or an intermediate state generated during, but not at the end of, the sequence of gate operations. A measurement apparatus 73 is configured to perform classical measurement on the final or intermediate quantum state, |ϕ_{ƒ} [symbol] _{such that the qubits within the register collapse to a particular value determined, ideally, by the probability density function defining their quantum states/wavefunctions. The register, once measured, may yield any one of a plurality of possible output states: x=(|}00 . . . 0), |01 . . . 0 [symbol] , . . . , |11 . . . 1 [symbol] )^{T}. The probability of each one of these output states, in practice, is not merely determined by the probability density function defining the quantum states of the register. Readout noise typically occurs which causes errors in the measured values generated by the measurement apparatus 73.

The ‘fidelity’ of a measurement operation by the measurement apparatus 73 quantifies how well the measurement value corresponds to the measurand. Fidelity depends on many factors. High-fidelity measurements allow for classical computers to faithfully extract information from the quantum computer processor or register. Measurements typically take place at the end of a quantum circuit operation. By repeating the executions of the quantum circuit, over many repeats (also known as ‘shots’), allows one to gather information about the distribution of the final states of a quantum computer processor or register in the form of a discrete probability distribution in the computational basis of the quantum circuit. This is schematically illustrated in FIG. 7, where the probability (N) of each possible output state is presented as a distribution.

It is desirable to be able to measure and reset a qubit in the middle of a quantum circuit execution. Mid-execution measurements allow a Boolean test for a property of a quantum state before the final measurement of the final state of a quantum computer processor or register takes place. For example, one may query, mid-execution, whether a register of qubits is in the plus or minus eigenstate of an operator formed by a tensor product of Pauli operators. These measurements are known as “stabilizer” measurements and are essential in many quantum error correction protocols. They signal the presence of an error to be corrected. Alternatively, mid-execution measurements can be used to validate the state of a quantum computer in the presence of noise, allowing for post-selection of the final measurement outcomes based on the success of one or more validation checks.

One significant limitation in the operation of noisy intermediate-scale quantum (NISQ) computers is the rate of errors and decoherence. Managing these errors is difficult because quantum bits (“qubits”) cannot be copied. Quantum register readout errors typically arise from the fact that qubit measurement times are significant in comparison to qubit decoherence times, meaning that a qubit in one state can decay to different state during a register measurement. In addition, and the probability distributions of measured physical quantities that correspond to two different qubit states may have overlapping support, and there is a small probability of mistakenly measuring the value of the wrong one of these two qubit states. The invention provides a means of using the distribution of the final states of a quantum computer processor or register, in the form of a discrete probability distribution in the computational basis of the quantum circuit. These distributions of measurements values, for the final states of a quantum register, quantify probability that a measurement value (x), or values (x), made by the measurement apparatus 73 of the quantum computer, is the result of a given true value of the quantum register (measurand (θ)) generated by the gates 72 of the quantum processor. This permits the user, or an automated system, to assign confidence values to final states of a quantum register, and/or to quantify uncertainty or risk when making decisions based on those measurement values.

### EXAMPLES

Referring once more to FIG. 1, in an alternative aspect of the invention, or in addition to aspects disclosed herein, an apparatus 1 is shown according to an embodiment of the invention.

FIG. 1 shows a measurement apparatus 1 according to an embodiment of the invention. The measurement apparatus comprises a measurement device 2 in the form of a sensor unit (e.g. an accelerometer, a magnetometer etc.) configured to generate measurements of a pre-determined measurable quantity: a measurand (e.g. acceleration, magnetic flux density etc.). The measurement 5 apparatus further includes a computer system 3 including a processor 4 in communication with a local buffer memory unit 5 and a local main memory unit 6. The computer system is configured to receive, as input, data from the sensor unit representing measurements of the measurand (e.g. acceleration, magnetic flux density etc.), and to store the received measurements in the local main memory unit 6. The processor unit 4, in conjunction with the buffer memory unit 5, is configured to apply to the stored measurements a data processing algorithm configured for sampling the measurements from a sensor stored in main memory, so as to generate sample sets of measurements which each represent the uncertainty in measurements made by the sensor unit 2 while also representing the measurand as accurately as the sensor unit may allow.

This representation of uncertainty may be achieved by generating the sample sets such that the distribution of measurement values within each of the sample sets represent the probability distribution of measurements by the sensor unit 2. Alternatively, the representation of uncertainty may be achieved by generating any appropriate form of approximating distribution that is derived from the distribution of measurement values within each of the sample sets, and which represents the distribution in e.g. a parameterised form. The computer system is configured to store the sample sets, once generated, in its main memory 6 and/or to transmit (e.g. via a serial I/O interface) the sample sets to an external memory 7 arranged in communication with the computer system, and/or to transmit via a transmitter unit 8 one or more signals 9 conveying one or more of the sample sets to a remote receiver (not shown). The signal may be transmitted (e.g. via a serial I/O interface) wirelessly, fibre-optically or via other transmission means as would be readily apparent to the skilled person.

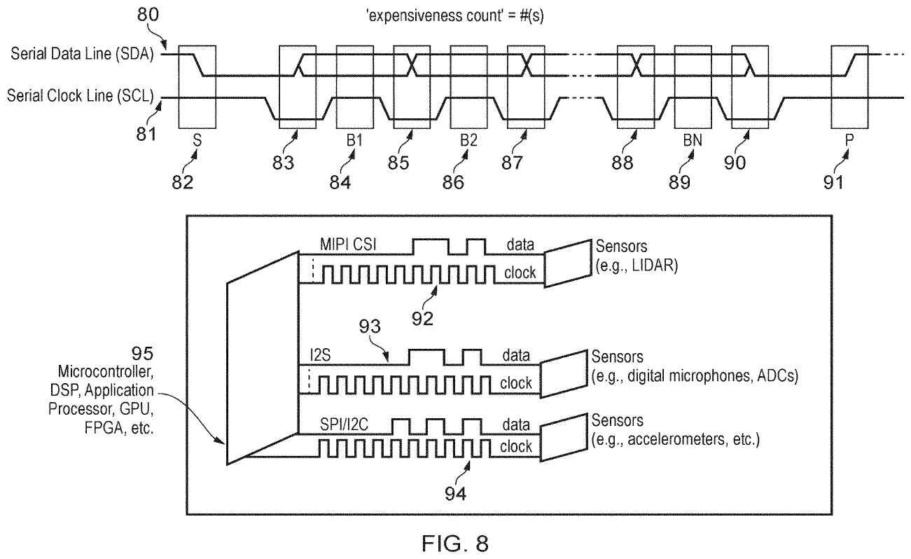

FIG. 8 shows an example of a timing diagram for a transmitter operating according to the I2C data transmission protocol, which will now be discussed to allow a better understanding of an example of the source of the cost function described above. The I2C (Inter-Integrated Circuit) protocol is a synchronous, multi-master, multi-slave, packet switched, single-ended, serial communication bus intended to allow multiple peripheral digital integrated circuits to communicate with one or more controller chips.

According to I2C, data transfer is initiated, at step 82, with a start condition (S) signalled by the serial data line (SDA, 80) being pulled to ‘low’ voltage while the serial clock line (SCL, 81) stays at ‘high’ voltage.

Next, at step 83, the serial clock line (SCL, 81) is pulled ‘low’, and the serial data line (SDA, 80) sets the first data bit level while keeping SCL low (i.e. during the time interval indicated by the time interval 83).

Next, the data are sampled (received) when the serial clock line (SCL, 81) rises for the first bit (B1). For a bit to be valid, the serial data line (SDA, 80) must not change between a rising edge of serial clock line (SCL) and the subsequent falling edge (i.e. the entire time interval indicated by the time interval 84).

This process repeats, with the serial data line (SDA, 80) transitioning while the serial clock line (SCL, 81) is ‘low’ (i.e. during the time intervals indicated by 85, 87, 88, 90), and the data being read while the serial clock line (SCL, 11) is ‘high’ (i.e. during the time intervals indicated by 84 . . . 89 for bits B2, . . . BN).

The final bit is followed by a clock pulse, during which the serial data line (SDA, 80) is pulled ‘low’ in preparation for the stop bit 91 (P). A stop condition (P) is signalled when the serial clock line (SCL, 81) rises, followed by the serial data line (SDA, 80) rising.

In this protocol, whenever a condition arises in which the serial data line (SDA, 80) or the serial clock line (SCL, 81) is set to ‘low’ (e.g. zero volts), then a potential difference (ΔV) is generated across a resistance (R) within the circuit. This expends a power (P) proportional to the square of the potential difference and inversely proportional to the resistance in question (i.e. P=(ΔV)²/R). This means that the cost function for an I2C data transmission is proportional to the number of times (#(s)) this condition is met. The more frequently it must occur, in order to complete a given transmission, then the more ‘expensive’ is the transmission. The cost function may then be defined as the ‘expensiveness count’ (#(s)) which is the count of the number of times that this condition is required to occur to achieve a transmission of a given signal.

Similar considerations apply to other signal transmission protocols, as schematically indicated in FIG. 8. Examples are MIPI CSI (Mobile Industry Processor Interface Camera Serial Interface), I2S (Inter-IC Sound), SPI (Serial Peripheral Interface) protocols which are regularly used to transmit signals (92, 93, 94) between various types of sensors (e.g. LiDAR, digital microphones, analogue-to-digital converters (ADC), accelerometers etc. etc.) and the receiving apparatus 95 they are in communication with (e.g. Microcontroller, digital signal processor (DSP), Application Processor, GPU, FPGA etc. etc.).

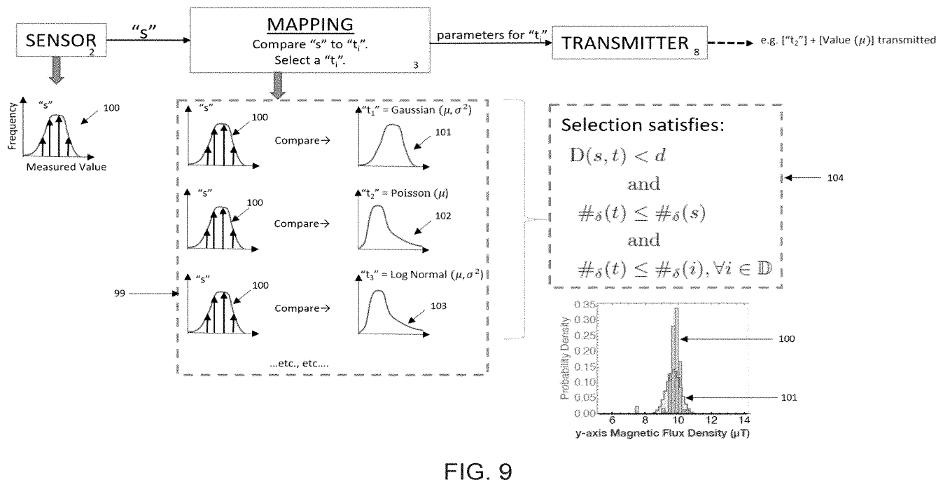

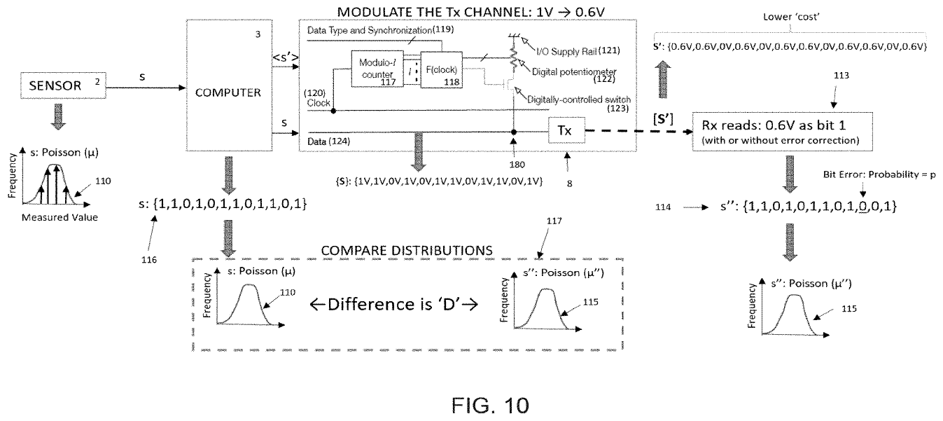

The computer system 3, of FIG. 1, is configured to implement a method of encoding a sample set of measurement data from a sensor unit 2 for transmission from a transmitter (e.g. via a serial I/O interface) via a method comprising the following data processing steps schematically illustrated in FIG. 9 or alternatively via a method comprising the following data processing steps schematically illustrated in FIG. 10.

### Re-Quantising Example 1:

Referring to FIG. 9, a first step is to obtain a data set (30) of measurements generated by the sensor unit 2. These may, for example, comprise a time-sequence of measurements (data elements) or may comprise non-sequential group of measurements which may, of desired, then ordered in time-sequence by the processor unit 4.

As a second phase of the data processing comprises the following steps, implemented by the processor unit 4 in conjunction with the buffer memory unit 5 of the computer system 3:
(a) The processor unit selects a sample set (“s”) of the sensor measurements (data elements) from amongst the data set of measurements stored memory unit 6, and places the sample set into the buffer memory unit 5. The selection of the sample set (which may comprise all of the data elements received from the sensor unit 2) quantifies the internal measurement uncertainty of the sensor unit 2 by providing, a distribution representing its measurement. The processor unit then compares the distribution (100) of the obtained sample set (“s”) to a plurality of different reference distributions (“tᵢ”; i=1, 2, 3, . . . ) stored in the main memory unit 6. This is indicated in process box 99 of FIG. 9. In doing so the processor determines a corresponding plurality of difference values each one of which quantifies a difference between the distribution (100) of the obtained sample set (“s”) and a respective one of the reference distributions (e.g. “t₁”: Gaussian(μ, σ²), 101; “t₂”: Poisson (μ), 102; “t₃”: Log-Normal(μ, σ²), 103; . . . etc.). Each reference distribution is, for example, one of a plurality of ‘named’ distributions or other distribution defined by one or more parameters. The one or more parameters may include, for example, a statistical ‘Moment’ of the reference distribution in question. Examples include: the first Moment (mean, μ), the second Moment (variance, θ²), third Moment (skewness), the fourth Moment (kurtosis), or a higher-order Moment of the reference distribution. For example, the plurality of different reference distributions stored in the main memory unit 6 may include a Normal distribution 101 defined by the values of its first and second Moments (mean, variance), and a Poisson distribution 102 defined by its first Moment value (mean) etc. The memory unit may store these reference distributions in terms of the parameters (μ, σ²) that define them.
(b) The processor unit determines, for each reference distribution, whether the difference value (the Kullback-Leibler (K-L) divergence) associated with that reference distribution (i.e. relative to the distribution of the obtained sample set) is less than a threshold difference value. If it is, then that reference distribution is deemed to satisfy a first condition.
(c) The processor unit determines, for each reference distribution satisfying the first condition, a respective value of a cost function. The cost function quantifies an energy requirement to transmit the reference distribution via the transmitter 8 and or via the e.g. serial I/O interface linking the computer system 3 to the external memory 7.
(d) The processor unit also determines, for the obtained sample set, a value of the same cost function thereby also quantifying an energy requirement to transmit the obtained sample set via the transmitter 8 and or via the e.g. serial I/O interface linking the computer system 3 to the external memory 7.
(e) Then, based on the cost function values determined at steps (c) and (d), the processor unit determines for each reference distribution whether the cost function value associated with it is less than the cost function value associated with the obtained sample set. If it is found to be a lower cost function value, then the reference distribution in question is deemed to satisfy a second condition, but otherwise it is deemed to not satisfy the second condition.
(f) The processor then selects, from amongst the reference distributions found at step (e) to satisfy the second condition, the reference distribution which has the lowest cost function value. This selected lowest-cost reference distribution is deemed to satisfy a third condition. Steps (b) to (f), described above, implement the following conditions for final selection at step (f):

$$D ( s , t ) > d$$

$$and$$

$${\#}_{δ} ( t ) \leq {\#}_{δ} ( s )$$

$$and$$

$${\#}_{δ} ( t ) \leq {\#}_{δ} ( i ) , ∀ i ∈ 𝔻$$

This is indicated in process box 104 of FIG. 9. Here, D(s,t) is the difference value between distributions s and t, whereas d is the threshold value for the difference. The quantity #_{δ}(t) is the cost function (or ‘expensiveness count’) for the transmission of the reference distribution whereas the quantity #_{δ}(s) is the cost function (or ‘expensiveness count’) for the transmission of the distribution of the received sample data set. The set [symbol] is the set of all reference distributions ‘t’ that satisfy the second condition.
(g) The processor then prepares a message for transmission, via the transmitter 8 and or via the e.g. serial I/O interface linking the computer system 3 to the external memory 7, using parameters defining the selected reference distribution (parameters for “tᵢ”) from step (f) for transmission as an encoded sample set approximating the obtained sample set of data.

In the example of FIG. 9, the selected reference distribution is “t₂”: Poisson (μ), 102. Accordingly, the encoded sample set simply comprises the identifier “t₂” which identifies that a Poisson distribution has been selected, together with the value of the mean (μ) of the Poisson distribution that has been found, by the processor unit 4 to satisfy all of the conditions stipulated by it, as described above. Alternatively, if the selected reference distribution had been “t₁”: Gaussian (μ, σ²), 101, or “t₃”: Log-Normal (μ, σ²), 103, then the encoded sample set would comprise the identifier “t₁” or “t₃” which identifies that a Gaussian distribution or a Log-Normal distribution has been selected, together with the value of the mean (μ) and the variance (σ²) of the distribution in question.

The computer system 3, and/or the transmitter unit 8, then transmit the encoded transmission when commanded to do so by the computer system 3, as and when required.

In this way, the computer system 3 adaptively determines the appropriate encoding to apply to the received sample set, from which to generate the optimal encoded sample set approximating the obtained sample set of data having a lower energy cost of transmission.

The processor unit 4 is configured to output each encoded sample set by one or more of: storing the encoded sample set in an external memory 7 and/or the local memory unit 6; transmitting a signal 9 comprising the encoded sample set via the transmitter unit 8; transmitting a signal comprising the encoded sample set from the computer system 3 to an external memory unit 7. In addition, the computer system 3 may store the received (un-encoded) sample set in local memory 6.

FIG. 9 shows an example of a representation for uncertainty of a sample set of measurements from a sensor 2. The figure shows a distribution of measurements whose uncertainty is represented using an empirical probability distribution in the form of a histogram 100. Overlaid on the histogram is a plot of a Gaussian distribution 101 having the same mean and variance. To capture/define the empirically observed distribution in FIG. 9 requires, e.g., eleven (11) triplets of: (1) bin boundary start, (2) bin boundary end, and (3) bin heights, to represent the eleven (11) bars of histogram distribution 100 of the sample set. Contrast this with just a single value for a sensor that outputs just a single (point-valued) number. The invention reduces this increase in data output by the apparatus of FIG. 1, which provides information on measurement uncertainty (a 33-fold increase in the case of the example 100 of FIG. 9). The overlay of the reference Gaussian distribution 101 upon the distribution of the sample set 100 demonstrates qualitatively how the distribution in the histogram is not best represented/encoded with the single value of its mean (or, even, with the mean and standard deviation). In this case, the apparatus of FIG. 1 may determine a better reference distribution with which to encode the sample data set 100 (e.g. a bi-modal reference distribution amongst the plurality of reference distributions available to it).

It is to be understood that the apparatus of FIG. 1 may be provided within/as an integrated sensor product/article comprising the computer system 3 and the sensor unit 2.

### Re-quantising Example 2

FIG. 10 shows an alternative method for re-quantising comprising the following data processing steps for encoding a sample set of measurement data from a sensor 2 for transmission from a transmitter 8 to a receiver 113. A first step is to obtain a data set (‘s’) of measurements generated by the sensor unit 2. These may, for example, comprise a time-sequence of measurements (data elements) or may comprise non-sequential group of measurements which may, of desired, then ordered in time-sequence by the processor unit 4.

As a second phase of the data processing comprises the following steps, implemented by the processor unit 4 in conjunction with the buffer memory unit 5 of the computer system 3:
(a) The processor unit determines a distribution 110 of the sample set (‘s’) of data. This comprises determining parameters of a probability distribution for the data within the sample set of data by calculating data which contains information defining the distribution of the sample set of data. This information comprises information defining the parameters of a distribution permitting the distribution to be reconstructed based solely on those parameters. As an example, information may comprise the positions (xᵢ) of data elements (e.g. their values) in the range of data values covered by the distribution, and the probability (p₁) values associated with each of those data values, giving: “(x₁, x₂, . . . , x_{N}; p₁, p₂, . . . , p_{N})” as the information. Other examples of parameters of a distribution include, but are not limited to: the type/name of a ‘named’ or pre-defined distribution (e.g. ‘Normal’, ‘Poisson’ etc.); the variables that uniquely define the ‘named’ or pre-defined distribution (e.g. mean, variance, ‘Moment’, etc.). As an example, information may comprise an identifier number or symbol which uniquely identifies a given ‘named’ distribution e.g. “1”=“Poisson”, and a value for the variable associated with that named distribution e.g. the mean, μ, giving: “(1, μ)” as the information. This second example is shown in FIG. 10, for illustrative purposes.
(b) Next, the processor generates a binary representation 116 of the distribution information for the distribution of the received sample set ‘s’. For example, the information “(1, μ)” defining the distribution of the received sample set as a Poisson distribution for the set, is represented in binary form as a bit string. As a simple schematic representation of this, the bit string is shown in the form s: {1, 1, 0, 1, 0, 1, 1, 0, 1, 1, 0, 1}in FIG. 10. This bit string is transmitted as data 124 from the computer 3 to a transmitter modulation unit 8 where it is converted into a corresponding sequence of voltages each representing a signal “bit”:

$$\{ S \} = \{ 1 V , 1 V , 0 V , 1 V , 0 V , 1 V , 1 V , 0 V , 1 V , 1 V , 0 V , 1 V \} ,$$

for transmission internally to a modulation point 180 where each signal “bit” is subjected to a signal modulation corresponding to a candidate binary representation s'received by the transmitter modulation unit from the computer 3. The computer 3 issues an instruction signal <s'> to the transmitter modulation unit for controlling the transmitter modulation unit to implement a modulation of the corresponding signal modulation (also referred to herein as a selected “candidate modulation”) of the received data {S}. After having received this modulation, each modulated signal “bit” is received by a transducer (Tx) of the transmitter modulation unit which generates and transmits a physical signal [S']. In the example of FIG. 10, the modulation applied to the sequence of voltages {S} was such as to reduce the voltage level of each one-volt (1V) signal “bit” from 1 volt to 0.6 volts, the resulting modulated sequence of voltages each representing a signal “bit” string of:

$$\{ {S}^{′} \} = \{ 0.6 V , 0.6 V , 0 V , 0.6 V , 0 V , 0.6 V , 0.6 V , 0 V , 0.6 V , 0.6 V , 0 V , 0.6 V \}$$

The transducer (Tx) of the transmitter modulation unit thereby generates the physical signal [S']according to this string of signal “bits”, using less energy to do so. As an example, transducer (Tx) of the transmitter modulation unit may be a diode laser which emits pulses of laser light to represent signal “bits” and the intensity of each laser pulse is proportional to the voltage of a given voltage signal “bit” received by the transducer. By reducing the voltage of signal “bits” from 1 volt to 0.6 volts, this reduces the energy required to transmit the signal “bits”. The signal bit modulation is implemented by a circuit within the computer system 3 comprising a clock signal line 120 connected to a Modulo-1 counter circuit 117 to provide a clock signal as input to the Modulo-/ counter circuit. The Modulo-1 counter circuit 117 comprises a plurality of output signal lines (“ ” in total) which are each input, respectively to a corresponding plurality of input signal ports (“T” in total) of an F-clock (or FCLK) 118. The FCLK controls the setting of a digital potentiometer 122, and the switch state (open/closed) of a digitally-controlled switch 123. The digital potentiometer is in electrical connection, at a first end of the potentiometer, to an I/O supply rail 121 and, at a second end of the potentiometer, is in electrical connection to the data transmission line 124. The digitally-controlled switch is located between the second end of the potentiometer and the data transmission line. When in the ‘closed’ position, the switch 123 places the data transmission line 124 in electrical connection with an I/O Supply Rail 121 via the digital potentiometer 122. As a result of this connection, the voltage level of the bit value is modulated by an amount which is proportional to the setting of the digital potentiometer. The setting of the digital potentiometer thereby defines the amount of modulation applied to a bit value (voltage) present upon the data transmission line 124 when the digitally-controlled switch 123 is in the ‘closed’ position. A Data Type and Synchronisation line 119 is connected to an input port of the F-clock and conveys control signals to the F-clock to prescribe the setting of the digital potentiometer 122 at any instant in time and to synchronise the application of a particular potentiometer setting with the occurrence of a target bit value upon the data transmission line to be modulated according to the stipulated potentiometer setting. In the example of FIG. 10, the application of this circuit to the input bit string:

$$\{ S \} = \{ 1 V , 1 V , 0 V , 1 V , 0 V , 1 V , 1 V , 0 V , 1 V , 1 V , 0 V , 1 V \} ,$$

is to produce a modulated output bit string,

$$\{ {S}^{′} \} = \{ 0.6 V , 0.6 V , 0 V , 0.6 V , 0 V , 0.6 V , 0.6 V , 0 V , 0.6 V , 0.6 V , 0 V , 0.6 V \}$$

(c) The computer system 3 generates a candidate binary representation 114 of the distribution, e.g. s″: {1, 1, 0, 1, 0, 1, 1, 0, 1, 0, 0, 1} by applying one or more bit errors (p) predicted to be made by the receiver 113 upon receipt of the modulated signal [S′] from the transmitter 8. For example, in the example of FIG. 10, signal [S′] is the result of the transducer (Tx) receiving the modulated sequence of voltages:

$$\{ {S}^{′} \} = \{ 0.6 V , 0.6 V , 0 V , 0.6 V , 0 V , 0.6 V , 0.6 V , 0 V , 0.6 V , 0.6 V , 0 V , 0.6 V \}$$

It is predicted that there is a significant probability that the receiver 113 will receive interpret the received transmission as the following bit string, s″: {1, 1, 0, 1, 0, 1, 1, 0, 1, 0, 0, 1}. This may occur because of the nature and performance of the receiver in question which may be configured to accept/interpret, with a probability ‘p’, that a received bit value of 0.6 was transmitted as (or was intended to represent) a bit value of 1. It may also occur if the receiver applies an error correction procedure to received bits and that error correction procedure will result, with a probability ‘p’, in a bit value received as 0.6 being ‘corrected’ to a bit value of 1. Note that, in the example of FIG. 10, the bit string 114 predicted to be provided by the receiver 113 is the bit string, s″: {1, 1, 0, 1, 0, 1, 1, 0, 1, 0, 0, 1}. The tenth bit (“0”) in this bit string 114 (in bold and underlined for emphasis) is a bit error in which the receiver has misinterpreted the transmitted value (0.6) of the tenth bit of the transmitted bit string as being a value of “0” (zero). In the input bit string, s: {1, 1, 0, 1, 0, 1, 1, 0, 1, 1, 0, 1} this bit has a value of “1”.
(d) The computer system 3 then reconstructs a distribution 115 of the sample set (s″) of data using the candidate (predicted) binary representation, s″: {1, 1, 0, 1, 0, 1, 1, 0, 1, 0, 0, 1}. This process of the computer 3 is schematically illustrated by process box 117 of FIG. 10. The format of the information conveyed by the bit string is “(3, μ)”, in this example, includes an identifier of the ‘type’ of the named distribution (i.e. “3” =“Poisson”), and a value for the variable associated with that named distribution i.e. the mean, p. This means that the reconstructed a distribution 115 of the sample set (s″) will contain an error. This error may occur in the value of the mean, μ→μ″μ, if the bit error in the predicted binary representation, s″, occurs in a bit forming part of the information conveying the value of the mean. The result is that the Poisson distribution of the reconstructed a distribution 115 would differ from the true Poisson distribution 110 for the sample set of data, to an extend depending on the relative impact that the bit error has on the reconstructed value of the mean. Of course, the location of the bit error within the bit string may have a strong influence on the degree to which μ″ differs from p. For example, if the first two bits of the bit string s: {1, 1, 0, 1, 0, 1, 1, 0, 1, 1, 0, 1} convey the identifier of the ‘type’ of the named distribution (i.e. “3”=“Poisson” as bits “11”), and the subsequent ten bits of the bit string convey the value of the mean (i.e. μ=365 as bits “0101101101”), then this is the binary representation of “(3, μ=365)”. The predicted binary representation, s″: {1, 1, 0, 1, 0, 1, 1, 0, 1, 0, 0, 1} corresponds to the binary representation of “(3, μ″=361)”. Here, the error in the value of the mean, μ→μ″≠μ, will have a small impact on the overall shape of the Poisson distribution received by the receiver. However, a different predicted binary representation, s″: {0, 1, 0, 1, 0, 1, 1, 0, 1, 1, 0, 1} in the bit string 114 may contain a bit error in the first bit (in bold and underlined for emphasis). This would correspond to the receiver misinterpreting the transmitted value (0.6) of the first bit of the transmitted bit string as being a value of “0” (zero). This bit string corresponds to the binary representation of “(3, μ″=109)”. Here, the error in the value of the mean, μ→μ″≠μ, will have a large impact on the overall shape of the Poisson distribution received by the receiver. In this way, the position of a bit error within the bit string can have a lesser (acceptable) or greater (unacceptable) impact on the information interpreted by the receiver.
(e) The computer system 3 then compares the distribution 110 of the sample set to the reconstructed distribution 115 to determine a difference value (D) quantifying a difference between the two distributions. This difference value may be a Kullback-Leibler (K-L) divergence value, or other suitable metric for quantifying a difference between two distributions, as would be readily apparent to the skilled person. This comparison process is schematically indicated in process box 117 of FIG. 10.
(f) The computer system 3 then selects a candidate binary representation for which the difference value (D) is less than a pre-set threshold difference value, and thereby selects the corresponding candidate modulation to apply at the transmitter modulation unit 8, at modulation point 80, for transmission of data from the transmitter to the receiver as an encoded sample set approximating the obtained sample set of data (e.g. approximated as a Poisson distribution).

As noted above, the processor considers a plurality of different candidate modulations to the bits of the bit string 116 thereby to generate a plurality of candidate binary representations (s′) of the distribution. The step (c) of generating a candidate binary representation (s″) 114 of the distribution 110 comprises generating a plurality of different candidate binary representations (s″) each of which corresponds to a respective one of a plurality different bit errors predicted to be made by the receiver 113 in response to it receiving the modulated output bit string:

$${s}^{′} : \{ 0.6 , 0.6 , 0 , 0.6 , 0 , 0.6 , 0.6 , 0 , 0.6 , 0.6 , 0 , 0.6 \}$$

from the transmitter 8. The computer determines a corresponding plurality of reconstructed distributions 115 of the sample set of data each of which is determined according to a respective one of the plurality of predicted candidate binary representations (s″). The computer compares, as shown in process box 117, the distribution 110 of the sample set to each one of the plurality of reconstructed distributions 115 thereby to determine a respective plurality of difference values (D) quantifying a difference between the distribution 110 of the sample set and a respective reconstructed distribution 115. The computer selects a candidate binary representation for which the difference value (D) is less than a pre-set threshold difference value. In this way, the computer excludes candidate binary representations (and corresponding candidate signal bit modulations) that have an unacceptably high probability of resulting in a reconstructed distribution, at the receiver, that is too different from the distribution of the received sample set.

For each candidate binary representation, the computer determines a respective value of a cost function, C1, quantifying an energy requirement to transmit using the corresponding candidate signal bit modulation [S′] via the transmitter 8. The computer also determines a value of the cost function C quantifying an energy requirement to transmit using the un-changed signal bit modulation for the binary representation 46 of the distribution of the obtained sample set—that is to say, the representation that has not been subject to bit modulation at modulation point 180 of the transmitter modulation unit 8. The computer then determines, for each candidate binary representation, and its corresponding candidate signal bit modulation, whether the cost function C1 value associated with it is less than the cost function value C2 associated with the un-modulated transmission of the distribution of the obtained sample set. This permits the computer to impose a “cost condition” whereby the step of selecting a candidate modulation for use in transmissions from the transmitter, comprises selecting the candidate binary representation (and its associated candidate modulation) only from amongst the candidate binary representations satisfying the cost condition: C1<C2. The computer selects the candidate binary representation (and its associated candidate modulation) with the lowest value of cost function, C1, that also satisfies the cost condition. This selected candidate modulation is then used by the transmitter to transmit the signal [S′] to convey the encoded sample set approximating the obtained sample set of data.

The memory unit 6 of the computer is provided with a Noise Model for the receiver device 113 which represents the distribution of induced bit error probabilities at the receiver. As a simple example, the Noise Model, M, may comprise a Normal/Gaussian probability distribution, N(μ,σ²), e.g. such as the form: M=1.0−N(Δ:μ,σ²) as a very simple example, that quantifies the probability of a bit error occurring for a given bit received at the receiver of a given a bit modulation (Δ). This provides a value for the probability (p) of a bit error for each respective one of the bits in a given bit string defining a given candidate bit modulation. When generating a predicted candidate representation of the distribution, the computer predicts occurrence of a bit error for a given bit modulation, according to the respective probability (p) of a bit error occurring for the given bit. A predicted bit error may be assumed to occur at the receiver if the respective probability is sufficiently high (p>threshold; e.g. threshold=0.5, or 0.6, or 0.7 etc.). In the above simple example, the Noise Model may vary the probability (p) of a bit error occurring for a given a bit modulation (Δ) by changing the value of the variance (σ²) of the Gaussian distribution in inverse proportion to the magnitude of the bit modulation (Δ). This results in a higher probability for a bit error as the magnitude of the bit modulation (Δ) increases. Of course, other more sophisticated Noise Models may be used as would be readily apparent to the skilled person: the simple example discussed here is provided to allow a better understanding of the invention.

In this way, the computer finds the ‘best’ signal bit modulation which balances the need to reduce the transmission ‘cost’ enough, while not incurring unacceptable bit errors at the receiver. The balance is struck by finding which signal bit modulations to apply at the transmitter modulation unit 8 to the signal bits representing of the data to be transmitted (i.e. to which bits and by how much), with the expectation that some bit errors will occur at the receiver, but intelligently accepting bit errors in bits that do not have a significant impact on the overall accuracy of the resulting data interpreted by the receiver.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1.-22. (canceled)

23. A computer-implemented method for sampling data from a measurement device for representing uncertainty in measurements made by the measurement device, the method comprising:
obtaining a data set comprising time-sequential data elements generated by the measurement device; and:
(a) calculating a statistic of a sub-set of data elements consecutive within the data set;
(b) comparing the value of the statistic to a reference value; and,
(c) if the value of the statistic differs from the reference value by less than a threshold amount, then: modifying the sub-set by appending to the sub-set at least one additional data element which is subsequent to the sub-set; and, repeating steps (a) to (c) for the modified sub-set of data elements;
(d) if the value of the statistic differs from the reference value by more than said threshold amount, then: outputting the sub-set collectively as a sample set of data elements generated by the measurement device for representing uncertainty in measurements made by the measurement device;
repeating steps (a) to (d) in respect of a subsequent sub-set of data elements consecutive within the data set.

24. The computer-implemented method of claim 23 wherein said outputting the subset comprises one or more of: storing the sample set in a memory; storing a calculated representation of the distribution of the sample set in a memory; transmitting a signal comprising the sample set; transmitting a signal comprising a calculated representation of the distribution of the sample set.

25. The computer-implemented method of claim 24 wherein the sample set is stored in a local memory or in a remote memory of a local or remote computer system, or memory unit.

26. The computer-implemented method of claim 23 wherein said modifying the subset comprises appending to the sub-set an additional data element which is immediately subsequent to the data element corresponding to the terminal data element of the sub-set.

27. The computer-implemented method of claim 23 wherein step (d) comprises removing from the sub-set a data element most recently appended thereto and outputting the result collectively as the sample set, and repeating steps (a) to (d) in respect of a subsequent sub-set of consecutive data elements within the data set including the data element so removed.

28. The computer-implemented method of claim 23 including constraining the size of the sub-set such that it is not less than a pre-set minimum number of data elements.

29. The computer-implemented method of claim 23 including constraining the size of the sub-set modified at step (c) such that it is not greater than a pre-set maximum number of data elements.

30. The computer-implemented method of claim 29 wherein, if the value of the statistic differs from the reference value by less than a threshold amount, and the size of the sub-set is greater than the pre-set maximum number of data elements, then the method includes:
outputting the sub-set collectively as a sample set of data elements generated by the measurement device for representing uncertainty in measurements made by the measurement device;
repeating steps (a) to (d) in respect of a subsequent sub-set of consecutive data elements within the data set.

31. The computer-implemented method of claim 23 wherein the statistic calculated in step (a) comprises a statistical moment or a function of the statistical moments of the distribution of said data elements.

32. The computer-implemented method of claim 23 wherein the reference value to which a said statistic of the modified sub-set is compared is determined according to the value of a said statistic in respect of the sub-set prior to said modification thereof.

33. The computer-implemented method of claim 23 wherein a measurand is measured at a sampling rate that is sufficiently higher than any systematic rate of change of the measurement or of the measurand, such that variation in the data within the data set is substantially not caused by the systematic changes.

34. The computer-implemented method of claim 23 wherein the time-resolution of the sampling of the measurand for generating sample sets for use in representing the measurement uncertainty of the measurement device is adaptively changed.

35. A method for representing uncertainty in measurements made by a measurement device comprising the steps of obtaining a sample set of data elements generated by a measurement device according to the method of claim 23, and calculating a representation of the distribution of the sample set of data elements to represent said uncertainty.

36. An apparatus for sampling data from a measurement device for representing uncertainty in measurements made by the measurement device, the apparatus comprising a processor method comprising:
a memory unit configured for storing an obtained data set comprising time-sequential data elements generated by the measurement device; and:
a processor configured to implement the following steps:
(a) calculate a statistic of a sub-set of data elements consecutive within the data set;
(b) compare the value of the statistic to a reference value; and,
(c) if the value of the statistic differs from the reference value by less than a threshold amount, then: modify the sub-set by appending to the sub-set at least one additional data element which is subsequent to the sub-set; and, repeat steps (a) to (c) for the modified sub-set of data elements;
(d) if the value of the statistic differs from the reference value by more than said threshold amount, then: output the sub-set collectively as a sample set of data elements generated by the measurement device for representing uncertainty in measurements made by the measurement device;
repeat steps (a) to (d) in respect of a subsequent sub-set of data elements consecutive within the data set.

37. The apparatus of claim 36 wherein the apparatus is configured for communication with an external memory and said outputting the sub-set comprises one or more of: storing the sample set in the external memory; storing a calculated representation of the distribution of the sample set of data elements in the external memory.

38. The apparatus of claim 36 further comprising a signal transmitter, wherein said outputting the sub-set comprises one or more of: transmitting a signal comprising the sample set; transmitting a signal comprising a calculated representation of the distribution of the sample set of data elements.

39. The apparatus of claim 36 wherein the processor is configured to modify the sub-set by appending to the sub-set an additional data element which is immediately subsequent to the data element corresponding to the terminal data element of the sub-set.

40. The apparatus of claim 36 wherein the processor is configured, at step (d), to remove from the sub-set a data element most recently appended thereto and to output the result collectively as the sample set, and to repeat steps (a) to (d) in respect of a subsequent sub-set of consecutive data elements within the data set including the data element so removed.

41. The apparatus of claim 36 wherein the processor is configured to constrain the size of the sub-set such that it is not less than a pre-set minimum number of data elements.

42. The apparatus of claim 36 further comprising the measurement apparatus.
